(19) United States
(12) Patent Application Publication
(10) Pub. No.: US 2009/0290476 A1
(43) Pub. Date: Nov. 26, 2009

(54) OPTICAL INFORMATION RECORDING MEDIUM, OPTICAL INFORMATION RECORDING/REPRODUCING APPARATUS, AND METHOD OF MANUFACTURING OPTICAL INFORMATION RECORDING MEDIUM

(76) Inventor: Mitsuya Okada, Tokyo (JP)

Correspondence Address: DICKSTEIN SHAPIRO LLP, 1633 Broadway, NEW YORK, NY, 10019, US

(21) Appl. No.: 11/720,925

(22) PCT Filed: Dec. 2, 2005
(86) PCT No.: PCT/JP05/22175

§ 371 Date: Jun. 5, 2007

(30) Foreign Application Priority Data
Dec. 6, 2004 (JP) 2004-352869

(51) Int. Cl. G11B 7/135; G11B 7/24; B32B 37/02

(52) U.S. Cl. 369/112.23; 369/275.1; 156/245; G9B/7.139; G9B/7.112

(57) ABSTRACT

An optical information recording medium, which has recording layers that include substrates of the same thickness and that correspond to laser light at two difference wavelength, has excellent compatibility.

An optical disk, in which recoding or reproduction is performed from one plane through the substrate, has two recoding layers, and the recording density of a first layer is different from the recording density of a second layer. First recording layer 101 and second recording layer 102 are stacked on substrate 1. The laser beam for recording or reproduction is incident through substrate 1. Structurally, the disk is formed by laminating two recording layers on the side opposite to the laser beam incident side. Intermediate layer 103 which is transparent to a second laser beam is formed between the first and second layers. Laser beam with different wavelengths is used to record or reproduce the first and second layers. The first layer is recorded or reproduced using an optical system which has first laser beam 21 at wavelength λ1 and objective lens 211 having numerical aperture NA1. The second layer is recorded on or reproduced using an optical system which has second laser beam 22 at wavelength λ2 and objective lens 221 having numerical aperture NA2.

### TECHNICAL FIELD

The present invention relates to an optical information recording medium, an optical information recording/reproducing apparatus, and a method of manufacturing an optical information recording medium, and more particularly, to an optical information recording medium which has a large capacity and is easy to use in terms of compatibility, an optical information recording/reproducing apparatus, and a method of manufacturing an optical information recording medium.

### BACKGROUND ART

Looking at the progress of file device technologies in recent years, the capacity of optical disks, which are one type of information recording media, has undergone a sudden increase. In a Read-only type, CD-ROM has generally become pervasive for use as music CD's and data distribution, and facilitates handling capacities ranging from 650 MB to 800 MB. Further, instead of CD which employs a laser at a wavelength near 780 nm in a near-infrared range as a light source, DVD made its appearance with red laser light at a wavelength near 650 nm employed as a light source. With the advent of this kind of DVD, seven times more information can be stored on a DVD than on a CD, and moving images can be recorded for two hours or more because of a capacity of 4.7 GB.

These Read-only disks record information by previously forming micro pits on a polycarbonate resin substrate. Write-Once optical disks, which have comparable reproduction performance, have also become rapidly widespread in recent years. The Write-Once optical disk has a polycarbonate resin substrate formed with a spiral guide groove, which is coated with an organic dye or the like which absorbs light at associated wavelengths, resulting in a multi-layered structure. Information can be recorded by forming pits and the like in a recording layer with focused laser light. After the pits and the like have been formed, the Write-Once disk exhibits reproduction characteristics and servo characteristics that are equivalent to the Read-only optical disk, so that data can be reproduced by a Read-only drive as well. Representative Write-Once optical disks include CD-R, DVD-R and the like.

In a recordable-type optical disk, on the other hand, rewritable optical disks have also become widespread, as they permit the user himself to rewrite data. CD-RW in the CD family, and DVD-RW, DVD-RAM, +RW in the DVD family are now available on the market. Each uses a phase change recording film. For example, GeSbTe, InSbTe, GeTe, SbTe, and metal thin films which contain additives that are added to these materials, are used for the recording film. For recording, a previously crystallized recording film is heated to its melting point or higher by laser light, and is subsequently cooled down rapidly to form an amorphous recording mark. On the other hand, for erasing, the recording film is crystallized by maintaining the recording film at its crystallization temperature or higher and gradually cooling down the recording film. The rewritable optical disk can be rewritten 1000 times or more.

All of the rewritable optical disks except for DVD-RAM have a physical format similar to that of CD-R or DVD-R, either of which is of the Write-Once type, and can be reproduced by commercially available Read-only drives although they have low reflectivity.

On the other hand, in research and development directed to still further increase the density of the optical disk, drive devices using a blue laser diode (LD) are now being aggressively developed, and some have already been commercially available as next-generation optical disks. In the optical disks, greater miniaturization of a focused spot can achieved because a laser is used for recording or reproduction has a shorter wavelength, so that recording or reproduction can be made at a higher density. With the use of LD at a wavelength of 405 nm, 15-25 GB can be recorded on a disk having the same size as a CD. In HD-DVD which is intended to increase the density while maintaining the compatibility with DVD, a Read-only type and a recordable type achieved a capacity of 15 GB, 20 GB, respectively, on each layer on one side, by using a substrate having a thickness of 0.6 mm similar to the DVD, and a design which directs an incident laser from the substrate side. On the other hand, in a BrD disk which is 0.1 mm thick and is irradiated with an incident laser directed from a cover layer, a recordable type has realized a capacity of 22 GB to 25 GB.

An increase in the number of layers is another approach to larger capacity. A dual-layer disk has already been employed in the DVD family, where a Read-only type has two layers of pre-pits on a substrate having a thickness of 0.6 mm via an intermediate layer which has a thickness of several tens of microns. The capacity per disk reaches 8.5 GB. Recently, a large capacity disk has been developed in the DVD-R family as well, where two recording layers are provided through an intermediate layer which has a thickness of several tens of microns. Also, in a system which employs the blue LD, an attempt has been under progress for a disk having two recording layers, and a dual-layer disk having a capacity of 50 GB has been developed in the BrD family.

As described above, developments have been steadily advanced for increasing the capacity of optical disks, whereas another important challenge is to create a link between the generations of optical disks, i.e., to ensure compatibility between disks such as CD and DVD, DVD and HD-DVD, and the like, which use different laser wavelengths and have different recording densities from each other. There are requests for reproducing past material (text information, image information and the like) recorded on CD's and the like by currently used drives as well. In some cases, information must be recorded on unused CD-R's which were purchased in the past, so that a need exists for a drive which can record or reproduce information beyond the past generation. In response to this, there are available on the market drives in which information can record on or reproduce from both CD and DVD. For example, a drive compatible between the CD family and the DVD family employs an optical head which is equipped with two LD's with wavelengths of 780 nm and 650 nm. The drive is configured to record or reproduce a CD using the LD with a wavelength of 780 nm, and to record or reproduce a DVD using the LD with a wavelength of 650 nm. Recently, efforts have been made to design the substrates of both DVD and HD-DVD so that the thickness from the laser incident surface to the recording surface is uniform at 0.6 mm to facilitate the compatibility of the drive between DVD and HD-DVD.

Another attempt has been made to link disks from one generation to another, other than the efforts to ensure compatibility of the drive. For example, in one form of an audio CD and a DVD disk, a recently developed disk functions as an audio CD when information is reproduced from one side of the disk and functions as a DVD disk when information is reproduced from the opposite side. This disk offers music provided by music CD to existing CD users, and high quality music provided by DVD or music video recorded on DVD to users who desire higher sound qualities. The disk is made up of a CD having a thickness of 1.2 mm and a DVD having a thickness of 0.6 mm which are bonded to each other, such that both reproducing surfaces are properly used depending on applications.

On the other hand, there are several related examples in the art of a disk which has a dual-layer structure that corresponds to two wavelengths of red LD and blue LD.

For example, Patent Document 1 (JP-A-2002-100072), which is an example of related art, discloses an optical disk which comprises a first substrate having a first storage area for radiating reflected waves in accordance with information stored thereon when it is irradiated with laser light of a blue light source, and a second substrate bonded to the first substrate and having a second storage area for radiating reflected waves in accordance with information stored thereon when it is irradiated with laser light of a red light source.

Also, Patent Document 2 (JP-A-2002-216391), which is another example of related art, discloses a one-side dual-layer disk which has a substrate formed with pits or grooves or the like on both sides thereof, and a surface cover layer formed on one side of the substrate, and in which laser beams having different wavelengths are directed from the surface cover layer side and concentrated on one side and opposite side of the substrate and information on the respective sides can be reproduced, or recorded and reproduced, or recorded, reproduced and erased.

As to a rewritable phase-change optical disk, Patent Document 3 (JP-A-2001-195777) discloses an exemplary disk structure for recording or reproducing information using two wavelengths. According to this exemplary disk structure, a first recording medium and a second recording medium are formed on a substrate through an adhesive layer, where the first recording medium is recorded or reproduced using a first laser light, while the second recording medium is recorded or reproduced using a second laser light. However, limitations are imposed on the two wavelengths of laser light used therein in that the difference therebetween falls within 120 nm or less. This is because the optical design of the disk is facilitated by limiting the conditions in which the wavelength can be used to a narrower range, with the result that desired conditions are more readily achieved for absorption and transmittance.

Also, Patent Document 4 (JP-A-10-40574), which is another example of related art, describes a one-side dual-layer disk on which information is recorded in two layers and read from one side of the disk in Paragraph [0021].

Further, Non-Patent Document 1 (H. A. Wierenga, “Phase change recording: Options for 10-20 GB (dual layer, high NA, and blue)”, Proceedings of SPIE, Optical Data Storage '98, 3401, 64-70 (1998)) discloses an approach for increasing the capacity, which involves a calculation for increasing the capacity in a dual-layer disk.

### DISCLOSURE OF THE INVENTION

However, the exemplary related arts have several problems. When considering recording or reproduction with both red laser light and blue laser light, any of the exemplary related arts does not provide an implementation which enables excellent compatibility between two types of disks which can use a substrate that has the same thickness, such as DVD and HD-DVD.

As illustrated in FIG. 13, the optical disk described in Patent Document 1 comprises substrate 1 having first recording layer 101 on the surface, and substrate 2 having second recording layer 102 on the surface, where the side of first substrate 1 opposite to the side formed with first recording layer 101 is bonded to the side of substrate 2 on which second recording layer 102 is formed, through adhesive layer 105. Cover layer 104 having a thickness of 0.1 mm thick overlies the side of substrate 1 on which first recording layer 101 is formed, through another adhesive layer 105. First recording layer 101 is irradiated with laser light 21 concentrated by objective lens 211 through cover layer 104, while second recording layer 102 is irradiated with laser light 22 concentrated by objective lens 212, to detect reflected light from respective recording layers 101, 102, thereby reading information. In such an optical disk, since cover layer 104 must be formed on substrate 1 which has first recording layer 101, the optical disk requires a cover layer bonding step which is different from a process for manufacturing the existing DVD, and the like, with associated difficulties related to the manufacturing. Also, since substrate 2 on which information is formed is bonded to the back side of substrate 1 on which information is formed, an excessive optical distance intervenes from the recording surface of first recording layer 101 to the recording surface of second recording layer 102, when viewed from an optical head. Thus, when information is recorded or reproduced by a head which has only one objective lens, it is very difficult to correct aberration. In addition, for accessing information accumulated on substrate 2, the laser light passes a total of two bonding layers four times, i.e., a first bonding layer which is bonded to cover layer 104 having a thickness of 0.1 mm, and a second bonding layer which bonds substrate 1 to substrate 2 in a going and a returning way. This can be a cause of introducing increased optical noise.

The structure disclosed in Patent Document 2 comprises a substrate formed with pits or groove or the like on both sides, and a surface cover layer on one side of the substrate, as described above. In other words, information is recorded or reproduced on one information recording surface through the cover layer having a thickness of 0.1 mm thick, while information is recorded or reproduced on the other information recording surface through both the cover layer and substrate. Accordingly, to access the two information recording surfaces, laser light must pass through the substrate and/or cover layer which have different thicknesses.

Further, in Patent Document 3, due to the restrictive condition in which the difference in wavelength between two lasers falls within 120 nm or less, a problem arises that the contents disclosed therein cannot be applied to the design of a dual-layer rewritable disk which supports DVD and HD-DVD (laser beams used therefor have wavelengths of 650 nm and 405 nm, respectively) which present a difference of 200 nm or more between their wavelengths, by way of example.

Patent Document 4 shows a one-side dual-layer disk on which information is recorded in two layers and read from one side of the disk, but this is a simple illustrative implementation of a DVD disk and is based on the premise that information on the two recording layers are accessed using laser light with a single wavelength.

Non-Patent Document 1 discloses an exemplary calculation for estimating an increase in capacity in a phase-changeable dual-layer medium which is recorded or reproduced at two wavelengths of 410 nm and 650 nm, respectively, but Non-Patent Document 1 simply compares capacities of single-layer structures at respective wavelengths, and shows the result of summing up these capacities. Any specific description is not given of a laminate made up of DVD and HD-DVD, for example, on the assumption that it is used with both red LD and blue LD.

It is an object of the present invention to provide an optical information recording medium which is an optical disk having at least two recording layers which support at least two different wavelengths, respectively, such as those of red LD and blue LD, despite a simple structure, an optical information recording/reproducing apparatus, and a method of manufacturing the optical information recording medium. Here, “recording/reproducing” means to have a single function of recording or reproduction, and both functions of recording and reproduction.

To solve the problems described above, the present invention employs characteristic configurations as follows.

(1) In an optical information recording medium which comprises at least two recording layers in which recorded data is formed on a substrate along a spiral or a concentric recording track, wherein in the optical information recording medium data is recorded or reproduced through the substrate,

a first recording layer is recorded or reproduced using first laser light at wavelength λ1, focused by an objective lens having a numerical aperture NA1, wherein the shortest pit length P1 of recorded or reproduced data has a value within a predetermined range determined by λ1 and NA1,

a second recording layer is recorded or reproduced using second laser light at wavelength λ2 that is longer than the wavelength λ1 of the first layer light, and the second laser light is focused by an objective lens having a numerical aperture NA2 equal to or smaller than NA1, wherein the shortest pit length P2 of recorded or reproduced data has a value larger than a value determined by λ2 and NA2, and

a track pitch of the first recording layer is narrower than a track pitch of the second recording layer.

(2) In an optical information recording medium which comprises at least two recording layers in which recorded data is formed on a substrate along a spiral or a concentric recording track, wherein in the optical information recording medium data is recorded or reproduced through the substrate, a first recording layer is recorded thereon or reproduced using first laser light at wavelength λ1, focused by an objective lens having a numerical aperture NA1, wherein the shortest pit length P1 of recorded or reproduced data satisfies a relationship represented by 0.167×λ1/NA1<P1<0.35×λ1/NA1,

a second recording layer is recorded or reproduced using second laser light at wavelength λ2 that is longer than the wavelength λ1 of the first layer light, and the second laser light is focused by an objective lens having a numerical aperture NA2 equal to or smaller than NA1, wherein the shortest pit length P2 of recorded or reproduced data satisfies a relationship represented by P2>0.35×λ2/NA2, and

a track pitch of the first recording layer is narrower than a track pitch of the second recording layer.

(3) The optical information recording medium (1) or (2) which has an intermediate layer formed between the first recording layer and the second recording layer, where the intermediate layer is transparent to either the first laser light or the second laser light.

(4) Any one of the optical information recording media (1)-(3), which has at least a second substrate on the two recording layers, and includes a print surface on the second substrate.

(5) The optical information recording medium (3) or (4), wherein a thickness d of the intermediate layer formed between the first recording layer and the second recording layer and having a refractive index n is set to a value between a first value determined by λ1 and NA1 and a second value determined by λ1, n, NA1, λ2, and NA2.

(6) The optical information recording medium (3) or (4), wherein thickness d of the intermediate layer formed between the first recording layer and the second recording layer and having a refractive index n satisfies a relationship represented by:

λ1/{π×(NA1)²}<d≦λ1×2n³/{(n²−1)×(NA1)⁴}+λ2×2n³/{(n²−1)×(NA2)⁴}

(7) Any one of the optical information recording media (1)-(6) for recording or reproducing data on or from a corresponding recording layer of at least two recording layers formed on a substrate, wherein unique information related to operations of a drive device for driving the optical information recording medium, is recorded in a system information recording area formed in a predetermined zone.

(8) The optical information recording medium (7), wherein information related to the number of recording layers, and information related to a wavelength for use in recording or reproduction of each recording layer are recorded in the system information recording area.

(9) The optical information recording medium (7), wherein information related to the number of recording layers, and information related to which Read-only type, Write-Once type, and rewritable type each recording layer belongs to, are recorded in the system information recording area.

(10) Any one of the optical information recording media (7)-(9), wherein the system information recording area is formed in a particular radial region.

(11) Any one of the optical information recording media (1)-(10), wherein a thin film of a dielectric material is formed on the first recording layer.

(12) The optical information recording medium (11), wherein the dielectric material is Si, Ge, silicon nitride (SiNx), germanium nitride (GeNx), silicon hydrate (SiH), germanium hydrate, silicon oxynitride, or germanium oxynitride.

(13) An optical information recording/reproducing apparatus for recording or reproducing an optical information recording medium which comprises at least two recording layers in which recorded data is formed on a substrate along a spiral or a concentric recording track, wherein in the optical information recording medium data is recorded or reproduced through the substrate, and wherein the optical information recording medium comprising:

a first recording layer for recording or reproducing data thereon or therefrom using a first laser light at wavelength λ1, concentrated by an objective lens having a numerical aperture NA1, wherein the shortest pit length P1 of recorded or reproduced data has a value within a predetermined range determined by λ1 and NA1; and

a second recording layer for recording or reproducing data thereon or therefrom using a second laser light at wavelength λ2 that is longer than the wavelength λ1 of the first layer light, wherein the second laser light is focused by an objective lens having a numerical aperture NA2 equal to or smaller than NA1, and the shortest pit length P2 of recorded or reproduced data has a value larger than a value determined by λ2 and NA2, wherein:

data is recorded or reproduced through the substrate, and

data on the first recording layer read by the first laser light is reproduced through partial response equalization, and data on the second recording layer read by the second laser light is reproduced through binary equalization.

(14) An optical information recording/reproducing apparatus for recording or reproducing data on or from an optical information recording medium which comprises two recording layers in which recorded data is formed on a substrate along a spiral or a concentric recording track, wherein in the optical information recording medium data is recorded or reproduced through the substrate, and wherein the optical information recording medium layers comprising:

a first recording layer for recording or reproducing data thereon or therefrom using a first laser light at wavelength λ1, focused by an objective lens having a numerical aperture NA1, wherein the shortest pit length P1 of recorded or reproduced data satisfies a relationship represented by 0.167×λ1/NA1<P1<0.35×λ1/NA1; and

a second recording layer for recording or reproducing data thereon or therefrom using a second laser light at wavelength λ2 that is longer than the wavelength λ1 of the first layer light, wherein the second laser light is focused by an objective lens having a numerical aperture NA2 equal to or smaller than NA1, and the shortest pit length P2 of recorded or reproduced data satisfies a relationship represented by P2>0.35×λ2/NA2, wherein:

data is recorded or reproduced through the substrate,

the wavelength λ1 of the first laser light is in a range of 390 nm to 430 nm, and the wavelength λ2 of the second laser light is in a range of 630 nm to 690 nm, and

data on the first recording layer is reproduced through partial response equalization, and recorded data on the second recording layer is reproduced through binary equalization.

(15) An optical recording/reproducing apparatus which comprises:

two laser diodes for emitting laser light at different wavelengths;

a light path for leading the laser light from the two laser diodes to objective lenses;

a phase compensation plate disposed immediately before each an objective lens, and exhibiting different phase characteristics depending on the wavelength; and

driving means for driving a lens actuator equipped with the objective lenses in a focusing direction.

(16) A method of manufacturing an optical information recording medium which comprises the steps of:

forming a first substrate, on a surface of which pre-pits are formed in a spiral form, by injection molding;

forming an Ag film on the pre-pits by a sputtering method to form a first recording layer;

forming a second substrate, on a surface of which pre-pits are formed in a spiral form reverse to those on the first substrate, by injection molding;

forming an Al—Ti alloy thin film on the pre-pits of the second substrate by a sputtering method to form a second recording layer;

coating an ultraviolet curable resin on the Ag film on the first substrate by a spin coating method to form an intermediate layer; and

bonding both the substrates such that the Al—Ti thin film side of the second substrate is laid on the first substrate, followed by irradiation by the curing ultraviolet rays from the first substrate side to cure the resin.

(17) A method of manufacturing an optical information recording medium which comprises the steps of:

forming a first substrate, on a surface of which pre-pits are formed in a spiral form, by injection molding;

forming an Ag film on the pre-pits by a sputtering method to form a first recording layer;

forming a second substrate, on a surface of which a groove is formed in a spiral form reverse to those on the first substrate, by injection molding;

sequentially laminating a laminate reflective film of Ag and Al—Ti, a ZnS—SiO₂ protection film, a GeSbTe phase change recording film, and ZnS—SiO₂ protection film on the groove of the second substrate by a sputtering method to form a second recording layer;

coating an ultraviolet curable resin on the Ag film of the first substrate by a spin coating method to form an intermediate layer; and

bonding both the substrates such that the protection film side of the second substrate is laid on the first substrate, followed by irradiation by the curing ultraviolet rays from the first substrate side to cure the resin.

(18) A method of manufacturing an optical information recording medium which comprises the steps of:

forming a first substrate, on a surface of which pre-pits are formed in a spiral form on a surface, by injection molding;

forming an Ag film on the pre-pits by a sputtering method to form a first recording layer;

forming a second substrate, on a surface of which a groove is formed in a spiral form reverse to those on the first substrate, by injection molding;

sequentially laminating, as a Write-Once recording layer, an Al—Ti reflective film, a ZnS—SiO₂ protection film, a GeTe recording film, and ZnS—SiO₂ protection film on the groove of the second substrate by a sputtering method to form a second recording layer;

coating an ultraviolet curable resin on the Ag film of the first substrate by a spin coating method to form an intermediate layer; and

bonding both the substrates such that the formed recording layer side of the second substrate is laid on the first substrate, followed by irradiation of the curing ultraviolet rays from the first substrate side to cure the ultraviolet curable resin.

(19) A method of manufacturing an optical information recording medium which comprises the steps of:

forming a first substrate, on a surface of which a groove is formed in a spiral form, by injection molding;

sequentially laminating, as a first recording layer, a ZnS—SiO₂ lower protection film, a GeSbTe phase change recording film, and a ZnS—SiO₂ upper protection film, an Ag reflective film, and a TiO₂ interference film on the groove of the first substrate by a sputtering method;

forming a second substrate, on a surface of which pre-pits are formed in a spiral form reverse to those on the first substrate, by injection molding;

forming an Al—Ti alloy thin film on the pre-pits by a sputtering method to form a second recording layer;

coating an ultraviolet curable resin on the TiO₂ interference film of the first substrate by a spin coating method to form an intermediate layer; and

bonding both the substrates such that the Al—Ti thin film side of the second substrate is laid on the first substrate, followed by irradiation by the curing ultraviolet rays from the first substrate side to cure the ultraviolet curable resin.

The present invention provides an optical information recording medium which has recording layers that include substrates of the same thickness and that correspond to laser light at two different wavelengths, and has excellent compatibility, and an optical information recording/reproducing apparatus.

An optical disk which is an optical information recording medium according to the present invention has two recording layers on a substrate, one of which is provided to be recorded or reproduced using laser light at a first wavelength, and the other of which is provided to be recorded or reproduced using laser light at a second wavelength. Either of the two layers are recorded or reproduced from the substrate side. In one of the two layers, a short wavelength laser is focused on miniature spots to record or reproduce information, and reproduction processing of multi-value equalization is performed using a PRML approach, actively taking advantage of waveform interference, thus making it possible to form pits, the density of which is increased in close proximity to the detection limit determined by the miniature spots in a line density direction. Also, information can be reproduced from such highly dense pits. On the other hand, in the other layer, recording or reproduction is performed on the premise that this layer is recorded or reproduced using laser light at a wavelength longer than the aforementioned short wavelength laser, attaching importance to compatibility with conventional disks having relatively low densities, by way of example. Further, reproduction processing is performed to binarize a reproduced signal waveform. Therefore, pits are formed at a density alleviated from the detection limit determined by the focused spot in the line density direction, and information can be satisfactorily reproduced from these pits.

An intermediate layer formed of a transparent resin or the like is interposed between these two layers to minimize cross-talk between the layers. Since the intermediate layer is the layer through which incident laser light has passed when accessing the second recording layer, the intermediate layer is only required to be transparent to the second laser light of incident laser light from the substrate side. In one implementation of the disk, a substrate may be formed on the surface opposite to the laser light incident surface in an equal thickness, and its surface may effectively serve as a print surface. The print surface can be used to display a label, an index indicative of contents, and the like, thus improving convenience. Further, for purposes of facilitating the distinction from other disks upon operation of a drive, a disk identification flag is effectively formed in part of the disk. Each layer can be formed with a Read-only recording layer which is formed with pre-pits, a Write-Once recording layer which uses a dye or the like in a recording film, and a rewritable recording layer which employs a phase change recording film or the like. Since the identification flag can describe information on functions which can be realized on each layer as a combination of the recording layers, conditions for a laser wavelength suited to each layer, and the like, an immediate disk recording or reproducing operation can be started.

A first advantage of the present invention is the ability to store the same contents in two versions, i.e., a high definition mode and a normal mode. For example, in one method, the same image contents such as a movie can be stored on the first layer in the HDTV mode (high image quality broadcasting mode), and stored on the second layer in the SDTV mode (normal image quality broadcasting mode). Taking advantage of the different recording densities, i.e., recording capacities of the two recording, layers, one can enjoy the same content with a single disk, irrespective of the device used for recording or reproduction, whether the device is an HDTV supporting model or an SDTV supporting model. Also, for providers who provide Read-only ROM disks, they need not sell the same software content in two modes (i.e., an HDTV-specific disk and an SDTV-specific disk), but advantageously, they are simply required to sell only one type of disk which has the structure of the present invention.

A second advantage is that a plurality of disks need not be prepared when information is communicated among a plurality of drives which do not have a disk compatibility function. For example, drive device A is a drive device which can record or reproduce both DVD and HD-DVD, while a drive device B is a drive device which only supports the DVD disk. In this event, when information is communicated between the two drive devices, the user is only required to prepare a disk which has two layers, one of which is in a high density mode comparable to HD-DVD, and the other of which is in a density mode comparable to DVD as the disk medium according to the present invention which comprises a Write-Once or rewritable recording layer, in order to communicate information between the two drive devices. Also advantageously, another disk medium need not be prepared for recording or reproduction by normal drive device A in the HD-DVD mode.

A third advantage is the ability to form a print surface on the surface of the substrate opposite to the laser light incident surface for visually confirming a title of information recorded on the disk, and the like. Therefore, there is the merit that the disk is user-friendly and can be easily managed.

### BRIEF DESCRIPTION OF THE DRAWINGS

FIG. 1A is a schematic diagram of an optical information recording medium which is one embodiment of the present invention.

FIG. 1B is a schematic diagram of an optical information recording medium which is one embodiment of the present invention.

FIG. 1C is a schematic diagram of an optical information recording medium which is one embodiment of the present invention.

FIG. 2 is a diagram showing a cut-off characteristic in an optical system of an optical information recording/reproducing apparatus according to the present invention.

FIG. 3 is a diagram showing an optical characteristic of the optical information recording medium which is one embodiment of the present invention.

FIG. 4A is a diagram showing another optical characteristic of the optical information recording medium which is one embodiment of the present invention.

FIG. 4B is a diagram showing another optical characteristic of the optical information recording medium which is one embodiment of the present invention.

FIG. 5 is a diagrammatic representation showing the placement of information recording areas of the optical information recording medium according to the present invention.

FIG. 6A is a diagram illustrating the configuration of an optical information recording/reproducing apparatus according to the present invention.

FIG. 6B is a diagram illustrating the configuration of the optical information recording/reproducing apparatus according to the present invention.

FIG. 7A is a diagram illustrating another configuration of the optical information recording/reproducing apparatus according to the present invention.

FIG. 7B is a diagram illustrating another configuration of the optical information recording/reproducing apparatus according to the present invention.

FIG. 8A is a schematic diagram of an optical information recording medium which is another embodiment of the present invention.

FIG. 8B is a schematic diagram of an optical information recording medium which is another embodiment of the present invention.

FIG. 8C is a schematic diagram of an optical information recording medium which is another embodiment of the present invention.

FIG. 9 is a diagram showing an optical characteristic of the optical information recording medium which is another embodiment of the present invention.

FIG. 10A is a diagram showing another optical characteristic of an optical information recording medium which is another embodiment of the present invention.

FIG. 10B is a diagram showing another optical characteristic of an optical information recording medium which is another embodiment of the present invention.

FIG. 11 is a diagram showing another optical characteristic of the optical information recording medium according to the present invention.

FIG. 12 is a diagram illustrating another configuration of the optical information recording medium according to the present invention.

FIG. 13 is a diagram illustrating the configuration of a conventional optical information recording medium.

### DESCRIPTION OF REFERENCE NUMERALS

1, 2 Substrates
3 Printing Surface
10 Optical Disk
11 Lead-In Area
12 Disk Identification Area
21, 22 Laser Light
101 First Recording Layer
102 Second Recording Layer
103 Intermediate Layer
104 Cover Layer
105 Adhesive Layer
151, 152, 153 Optical Heads
201, 202 Laser Diodes (LD)
211, 221, 231 Objective lenses
232 Phase Compensation Plate
301 Recording/Reproducing Circuit
302 PRML Equalizer Circuit
303 Binary Equalizer Circuit

### BEST MODE FOR CARRYING OUT THE INVENTION

Next, embodiments of the present invention will be described in detail with reference to the drawings.

An optical information recording/reproducing medium of the present invention, which is an optical disk, is of a type that is recorded or reproduced from one side through a substrate, and has two recording layers which include a first layer and a second layer that differ in recording density.

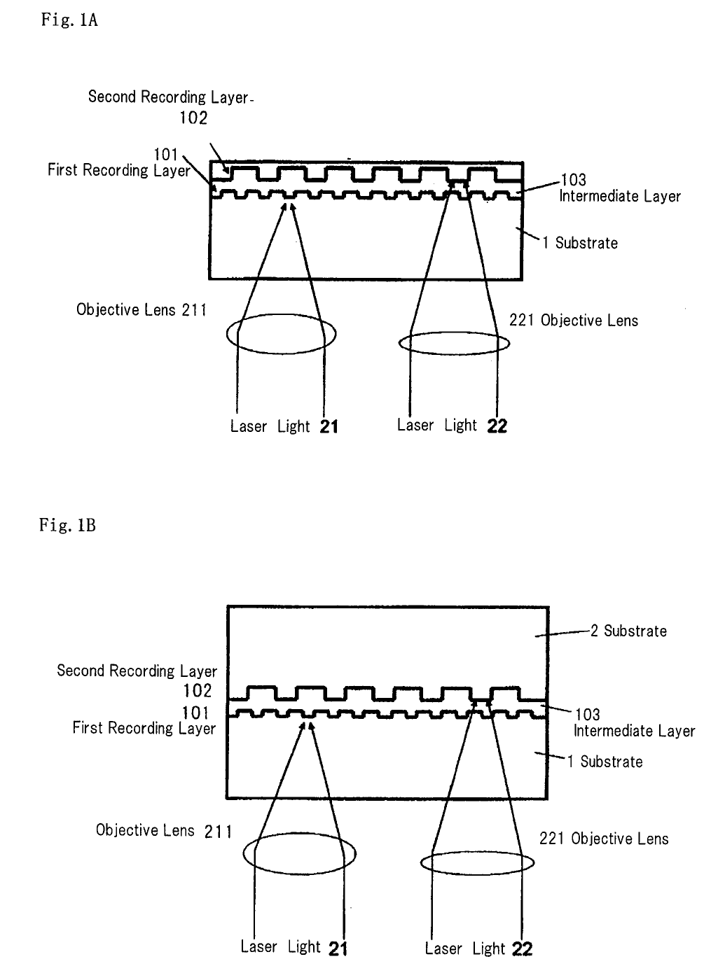

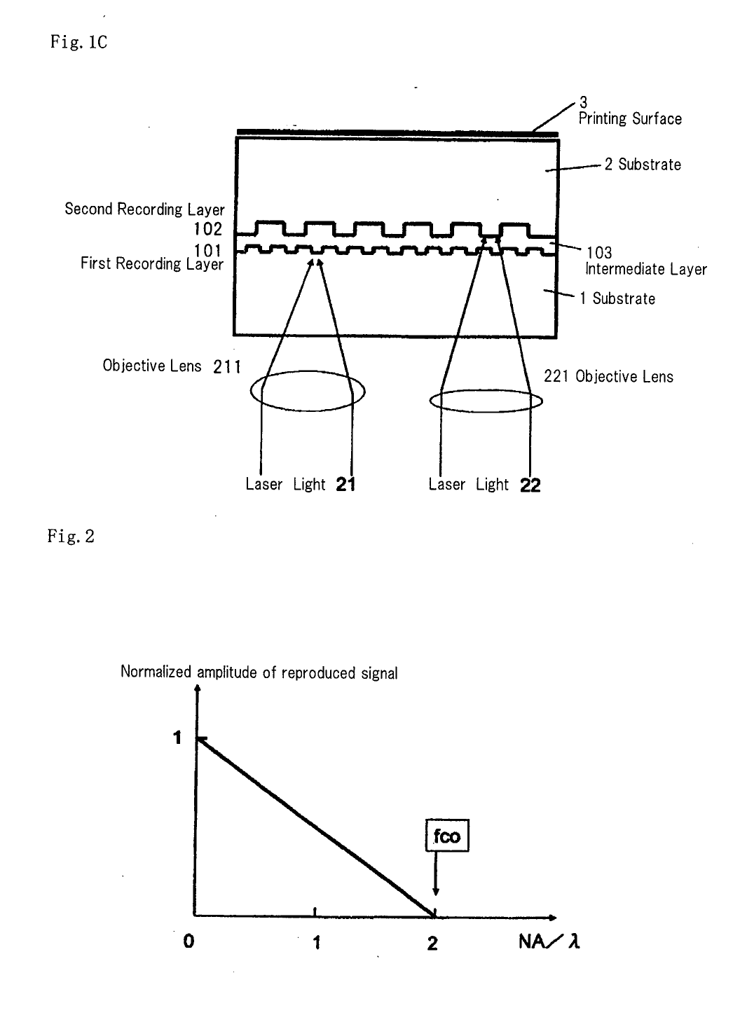

FIG. 1A is a cross-sectional view illustrating a typical configuration of an optical disk according to the present invention. Referring to FIG. 1A, this optical disk has a structure which comprises first recording layer 101 and second recording layer 102 laminated on disk substrate 1. Laser light for recording or reproduction is incident through substrate 1. Structurally, the disk is formed by laminating two recording layers on the side opposite to the laser light incident side. Intermediate layer 103 is formed between the first and second layers. Intermediate layer 103 is transparent to second laser light, later described.

The present invention is also characterized by recording or reproducing the first and second layers using laser light having different wavelengths. Specifically, the first layer is recorded or reproduced using an optical system which has first laser light 21 at wavelength λ1 and objective lens 211 having numerical aperture NA1. The second layer is recorded on or reproduced using an optical system which has second laser light 22 at wavelength λ2 and objective lens 221 having numerical aperture NA2.

The first layer differs from the second layer in recording density because the objective lenses for use in recording or reproduction have different NA's, and different signal processing methods are employed in a reproduction system. The recording density of the first layer is designed to satisfy a relationship P1<0.35×λ1/NA1, where P1 represents the length of the shortest pit. The recording density of the second layer is designed to satisfy a relationship P2>0.35×λ2>NA2, where P2 represents the length of the shortest pit. The recorded shortest pit on the first layer is smaller than that on the second layer because they are based on the premise that PRML (Partial Response Maximum Likelyfood) signal processing is used for reproduction from the first layer. In this way, even information recorded at a high density can be satisfactorily reproduced. In addition, the track pitch on the second layer is wider than that on the first layer because the different wavelengths result in different focused spot sizes.

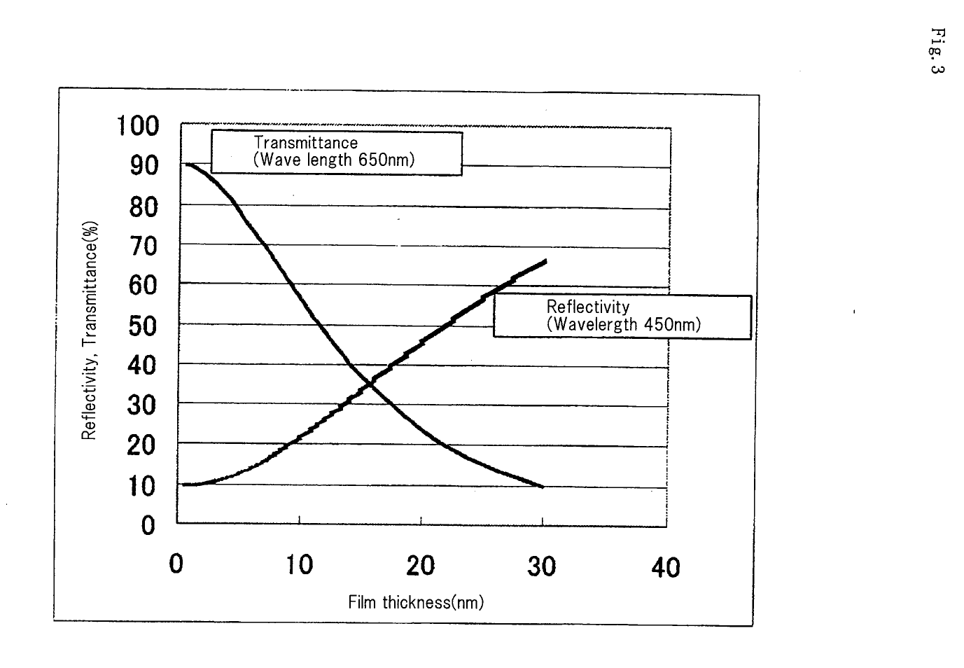

As is previously well known, in optical recording represented by the optical disk, laser light is focused by an objective lens on a miniature spot which is used to record data on a recording medium or reproduce recorded data. Generally, the recording density depends on the size of the miniature spot. The size of the miniature spot is proportional to wavelength λ, and reciprocally proportional to NA of the objective lens. The size of pits formed on a recording medium is determined in a range in which this miniature spot can be used to yield sufficient reproduction characteristics. As the size of the recorded pit is smaller, a reproduced signal generated from the recorded pit has a smaller amplitude. As illustrated in FIG. 2, cut-off frequency fco, at which the amplitude of a signal reproduced from a recorded pit is zero, is defined by:

fco=2×NA/λ

This indicates that recorded pits which cause a reproduced signal to have zero amplitude appear at a period of 0.5×λ/NA.

Assuming so-called mark edge recording in which recorded information is borne on edge portions of a recorded pit, the amplitude of a reproduced signal becomes zero when the pit length is 0.25×λ/NA. The mark edge recording slices a transition region of a reproduced signal which falls within the mark edge for binarization to reproduce desired data. In a binarization reproducing method based on mark edge recording, since no signal can be reproduced when the shortest pit length is reduced to 0.25×λ/NA, the shortest pit length is set near 0.37×λ/NA or more. For example, in the case of a CD, the shortest pit length is placed in a relationship of 0.48×λ/NA because the wavelength is at 780 nm, NA is 0.45, and the shortest pit length is 0.83 μm. In the case of a DVD, on the other hand, the shortest pit length is placed in a relationship of 0.37×λ/NA because the wavelength is at 650 nm, NA is 0.60, and the shortest pit length is 0.40 μm.

On the other hand, the PRML signal processing method which actively utilizes reproduced waveform interference has been increasingly applied in order to increase the density in recording or reproduction. This method actively utilizes waveform interference which occurs between the preceding and subsequent pits during reproduction, and equalizes multi-value waveforms on the premise that the interference exists. In this event, the shortest pit length can be set to a value closer to the aforementioned cut-off frequency fco. For example, in the HD-DVD which uses a blue laser diode as a light source, PRML is used for a reproduced signal, where the shortest pit length is placed in a relationship of 0.28×λ/NA because the wavelength is at 405 nm, NA is 0.65, and the shortest pit length is 0.173 μm, with the intention of increasing the density in the line density direction.

In the PRML signal processing method described above, a signal from the shortest pit need not be always reproduced as a sufficient output signal. Assuming a case where maximum density has been realized, it is only required that the shortest pit and a pit longer than the shortest pit by one unit can be recognized. For example, assuming that the shortest pit length is equal to 2 T, and the pit longer than the shortest pit by one unit is 3 T, where T represents a clock, the pit equal to 3 T may have a length placed in a relationship of 0.25×λ/NA. In this case, the lower limit of the shortest pit can be permitted up to 0.167×λ/NA.

The present invention employs a disk substrate having a thickness of approximately 0.6 mm. Laser light for recording or reproduction is incident through the substrate. While the substrate itself is only required to be transparent to the laser light wavelength that is used, the substrate is generally made of a resin represented by polycarbonate. When the substrate itself is required to be rigid, a glass substrate can be used as well.

In one implementation of the disk, two recording layers 101, 102 are laminated on the side opposite to the laser light incident side, as illustrated in FIG. 1A. Intermediate layer 103 is formed between the first and second layers. Intermediate layer 103 is sufficiently transparent to at least laser light for accessing the second recording layer. Intermediate layer 103 may be formed by spreading a transparent resin, or by uniformly adhering a film-like transparent thin film sheet.

This intermediate layer 103 is needed in order to distinguish the position, where laser light is focused, on at least the first and second recording layers, and its thickness is required to be larger than at least focus depth Δz which is determined by numerical aperture NA of an objective lens and laser light wavelength λ. When Δz is defined to be a distance from the focused position, at which the peak intensity of a focus spot is reduced to 50%, Δz can be approximated by:

Δz=λ/{π×(NA)²} (1)

For example, when λ=650 nm, and NA=0.60, Δz=0.58 μm, so that the intermediate layer needs a thickness of 1 μm or more even if it is formed as thin as possible.

On the other hand, a maximum value permitted for the thickness of the intermediate layer is determined from aberration conditions of the objective lens. Consider a case in which an intermediate layer having refractive index n and thickness Δd is added to the thickness of a substrate which was determined during the designing of the objective lens, thus causing the thickness of the substrate to change by Δd. Assuming that spherical aberration W₄₀ that is allowable to the objective lens is λ/4,

W₄₀={(n²−1)(NA)⁴/8n³}×Δd (2)

so that:

Δd<Δ×2n3/{(n²−1)×NA⁴} (3)

For example, when λ=650 nm, NA=0.60, and n=1.56, Δd<26.6 μm. Accordingly, assuming that allowable spherical aberration W₄₀ is limited to ±λ/4, both recording layers can be recorded or reproduced at this wavelength within the allowable aberration when two recording layers are disposed within ±26.6 μm. Also, when λ=405 nm, NA=0.65, and n=1.56, Δd<12.0 μm.

Since the present invention employs two laser beams at different wavelengths and objective lenses having different NA's from each other for recording or reproduction, thickness d of the intermediate layer must be set in an allowable range in consideration of the two wavelengths and two NA's. Generally, an objective lens of an optical head equipped in a recording/reproducing apparatus is designed on the assumption that recording or reproducing operations are performed on an optical disk medium that has only one recording layer. Since it is necessary that a dual-layer optical disk medium, according to the present invention, can also be satisfactorily recorded or reproduced even in a recording/reproducing apparatus which is designed on the assumption that recording or reproducing operations are performed on such an optical disk medium that has only one recording layer, this requirement must be taken into consideration in setting the configuration of layers in a dual-layer optical disk medium, particularly, the placement of each layer and the thickness of the intermediate layer.

Specifically, when a single-layer medium having only one recording layer is formed on a substrate having thickness h, the dual-layer medium may have two layers, each of which may be formed within a range of Δd with respect to thickness h, such that the spherical aberration remains below a fixed allowable value. However, as described above, since this Δd differs depending on the wavelength and NA, the thickness of the intermediate layer must be determined such that each layer is formed within an allowable value for deviations in thickness, determined from both wavelengths and both NA's, when two wavelengths are used and laser light is focused by objective lenses having different NA's, as in the present invention.

For example, when the allowable value for deviations in the thickness of the substrate is Δd1, as determined from the objective lens conditions of wavelength λ1 and NA1, and the allowable value for deviations in the thickness of the substrate is Δd2, as determined from the objective lens conditions, i.e., wavelength λ2 and NA2, the first recording layer for use under the objective lens conditions of wavelength λ1 and NA1 may be formed to fall within a range from thickness (h−Δd1) to thickness h, viewed from the surface of the substrate on the incident side, while the second recording layer for use under the objective lens conditions of wavelength λ2 and NA2 may be formed to fall within a range from thickness h to thickness (h+Δd2), viewed from the surface of the substrate on the incident side, with the result that the aberration condition is satisfied. Conversely, when the first recording layer for use under the objective lens conditions of wavelength λ1 and NA1 may be formed to fall within a range from thickness h to thickness (h+Δd1), viewed from the surface of the substrate on the incident side, while the second recording layer for use under the objective lens conditions of wavelength λ2 and NA2 may be formed to fall within a range from thickness (h−Δd2) to thickness h, viewed from the surface of the substrate on the incident side, a similar aberration condition is satisfied.

Since wavelength λ1 is shorter than wavelength λ2, and NA1 is equivalent to NA2 or NA1 is larger than NA2, a minimum value for the thickness allowed to the intermediate layer is determined from Equation (1), λ1 and NA1.

λ1/{π×(NA1)²}<d (4)

Also, a maximum value for the thickness allowed to the intermediate layer is determined in the following manner using Equation (3), on the assumption that the spherical aberration is allowed up to λ/4.

d=Δd1+Δd2

<λ1×2n³/{(n²−1)×(NA1)⁴}+λ2×2n³/{(n²−1)×(NA2)⁴} (5)

In this way, the maximum value for thickness d of the intermediate layer can be determined from the aberration conditions of the objective lenses.

For example, when an objective lens having NA1 for wavelength λ1 and an objective lens having NA2 for wavelength λ2 are both designed on the assumption that a single-layer medium has a substrate having a thickness of 0.6 mm, Δd1 is calculated to be approximately 12 μm thick and Δd2 approximately 26 μm thick, in which λ1=405 nm, NA2=0.65, λ2=650 nm, NA2=0.60, and n=1.56. Accordingly, the first recording layer for wavelength λ1 may be formed on a first substrate, with the first substrate having a thickness of 0.588 mm and the intermediate layer having a thickness of 38 μm thick, and the second recording layer for wavelength λ2 may be formed on the intermediate layer after the formation of the intermediate layer, resulting in a medium which satisfies desired aberration conditions.

First recording layer 101 and second recording layer 102 may be of a ROM type which is formed with pre-pits, or of a Write-Once type or a rewritable type which has a recording film formed on a groove. The two layers may be of the same type, or may be of different types such as ROM and Write-Once types, ROM and rewritable types, or Write-Once and rewritable types.

In the present invention, the first layer is recorded or reproduced by an optical system which has laser light 21 at wavelength λ1 and objective lens 211 having NA1, while the second layer is recorded or reproduced by an optical system which has laser light 22 at wavelength λ2 and objective lens 221 having NA2, so that first recording layer 101 formed in the first layer is required to have a desired transmittance to laser light 22 at wavelength λ2.

For example, when first recording layer 101 is a Read-only ROM, a metal reflective film is formed on pre-pits area of the disk, whereas in the dual-layer structure of the present invention, a material must be selected for the metal reflective film such that the film exhibits a desired reflectivity to Δ1 and simultaneously exhibits a fixed transmittance to λ2, and the film must also be adjusted in thickness. FIG. 3 is a characteristic diagram showing the dependence of the reflectivity to λ1 and the transmittance to λ2 on the film thickness when Ag is selected for the metal reflective film, with wavelength λ1 of first laser light 21 being at 405 nm and wavelength λ2 of second laser light 22 being at 650 nm. The thickness reduced to less than 5 nm would result in the transmittance to λ2 equal to or higher than 80%, but the reflectivity to λ1 equal to or lower than 12%. In a film having a thickness of approximately 12 nm, the reflectivity of approximately 25% can be ensured to λ1. In this event, since the transmittance to λ2 is approximately 50%, data can be recorded on or reproduced from second recording layer 102 without a hitch.

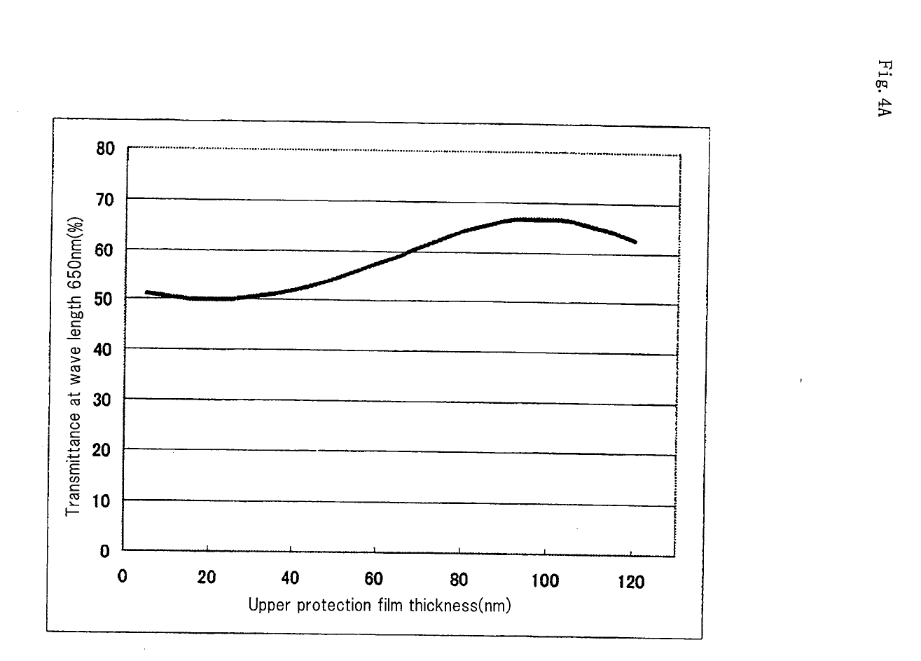

For example, when first recording layer 101 is of the rewritable type, a phase change recording film is selected, the thickness of the recording film itself is reduced, and the metal reflective film is also formed having a reduced thickness to improve the transmittance, in order to produce a heat radiation effect. In this way, first recording layer 101 can exhibit the desired reflectivity to λ1, and a fixed transmittance to λ2. FIG. 4 shows the reflectivity (FIG. 4B) to the wavelength of 405 nm and the transmittance (FIG. 4A) to the wavelength of 650 nm when a lower protection film is 70 nm thick; a GeSbTe phase change recording film is 5 nm thick; an Ag reflective film is 10 nm thick, and an interference film is 20 nm thick in a structure comprised of sequentially laminated substrate/ZnS—SiO₂ lower protection film/GeSbTe phase change recording film/ZnS—SiO₂ upper protection film/Ag reflective film/TiO₂ interference film. Though both change depending on the thickness of the upper protection film, when the thickness of the upper protection film is set to 35 nm, a crystal portion of the recording film exhibits the reflectivity of 18% to the wavelength of 405 nm, an amorphous portion of the recording film exhibits the reflectivity of 12% to the wavelength of 405 nm, and the average transmittance is 52% at wavelength of 650 nm. In this way, when first recording layer 101 is chosen to be of the rewritable type, the transmittance of 50% or more can be achieved to the second recording layer 102, so that data can be recorded on or reproduced from second recording layer 102 without a hitch.

Likewise, when a Write-Once type recording film made of an organic dye material, an inorganic metal material or the like is formed in first recording layer 101, a material which has a fixed transmittance to the second wavelength, though it absorbs the first wavelength, may be selected for first recording layer 101, or the recording layer may be reduced in thickness, whereby data can be recorded on or reproduced from second recording layer 102 without a hitch.

On the other hand, since second recording layer 102 is similar to the conventional substrate incident type single layer, smaller consideration may be given in mind in regard to the structure of the layer and materials used therefor. However, due to a lower transmittance to the recording layer as compared with the single-layer structure, a higher reflectivity is more preferably set for second recording layer 102.

In the present invention, wavelength λ1 is different from wavelength λ2, but the density of the first recording layer is increased, so that λ1 is set in a range of 390 nm to 450 nm, which are wavelengths of blue, and preferably to 405 nm. For λ2, on the other hand, a red wavelength is preferably used in consideration of the compatibility with the existing DVD, so that λ2 is set in a range of 630 nm to 690 nm, and more preferably to 650 nm. For objective lens 211 or 221, the one that has large NA is used for wavelength λ1 associated with the first recording layer whose density is increased. For example, an objective lens for wavelength λ1 can have NA=0.65, and an objective lens for wavelength λ2 can have NA=0.60. The disk may have the two recording layers formed on a single substrate having a thickness of 0.6 mm, but as illustrated in FIG. 1B, after second recording layer 102 has been previously formed on second substrate 2, first substrate 1 and second substrate 2 may be bonded to each other through intermediate layer 103 which is an adhesive layer, such that their recording layers oppose each other to strike a balance therebetween. In this case, as shown in FIG. 1C, the surface (substrate surface) opposite to the laser light incident surface may be used as print surface 3 for visually displaying a title or the like of information recorded on the disk to facilitate the confirmation of contents. A label, a title, an index indicative of contents, for example, can be printed on print surface 3. Alternatively, a label or a title printed on a film, an index indicative of contents, or the like may be adhered on the substrate surface. In one implementation, the substrate surface may be printed or coated with a film such that the user himself can write information such as the label, title or the like. With the employment of such an implementation, it is possible to provide a user-friendly form of disk.

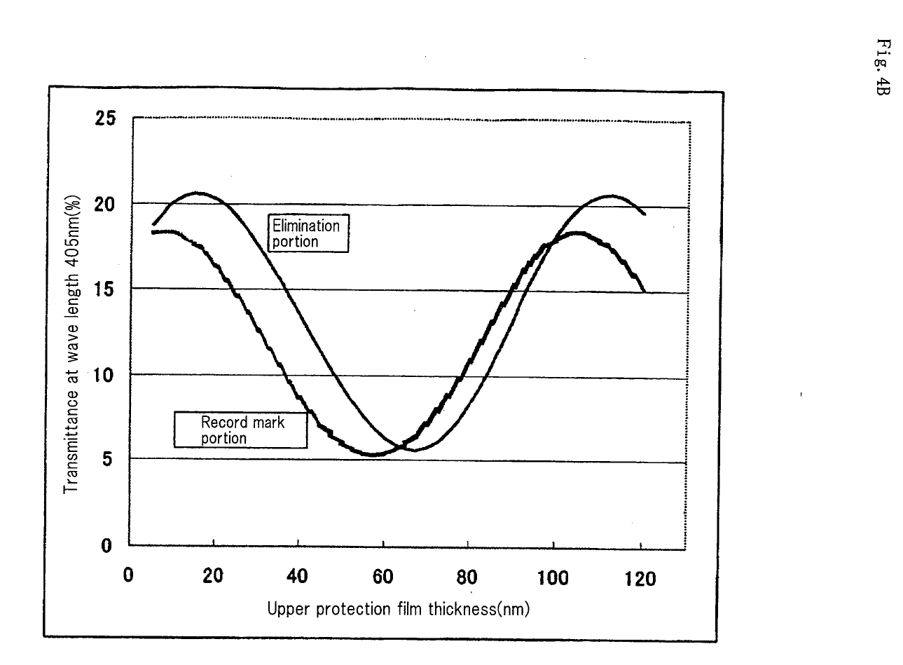

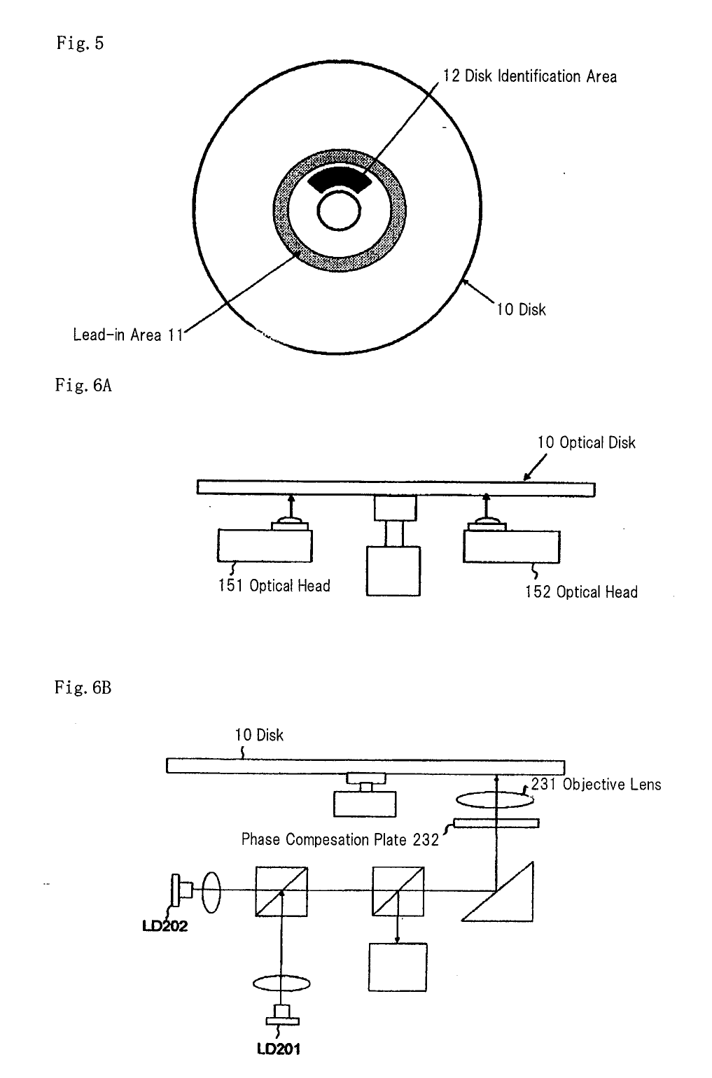

Information is recorded on or reproduced from the disk using a drive device, but for identifying the type of the disk in the drive device, it is useful to form the disk itself with flag information. In the present invention, a system control information area is provided on part of the disk for recording a disk identification flag therein. For example, as illustrated in FIG. 5, system control information area 11 called “Lead-in” is formed in an inner-most region of disk 10. This system control information area 11 records a flag for identifying the type of the disk, such as information related to which of the three types, Read-only type, Write-Once type, and rewritable type, each recording layer is classified into, the number of layers in the recording layers, used wavelengths, and the like. Also, stripe disk identification area 12 may be provided in an interior zone for recording information by changing the reflectivity in stages, and the disk identification flag information may be stored here. In this way, the system control information area and disk identification area can be used as a system information recording area.

More specifically, regions whose reflectivity is different from each other may be provided in a bar code shape so as to store the disk identification flag information therein. For example, four bits are assigned as a disk identification flag, and used in order from the least significant bit, as a bit for recording information on “a single-layer disk having only one recording layer or a dual-layer disk,” a bit for recording information on “which of wavelengths λ1 and λ2 is used for the first layer,” a bit for recording information on “which of wavelengths λ1 and λ2 is used for the second layer,” and a spare bit. For example, when the assigned four bits are “0011,” they represent a dual-layer disk in which λ2 is used for the first layer, and λ1 is used for the second layer. When the assigned four bits are “0101,” they represent a dual-layer disk in which λ1 is used for the first layer, and λ2 is used for the second layer. When the assigned four bits are “0000,” they represent a single-layer disk in which λ2 is used for the first layer.

This area may record not only information for identifying the type of the disk, as represented by information on which of three types, Read-only, Write-Once, and rewritable types, each recording layer is classified into, but also identification information including information on the number of layers in the recording layer, and information on a used wavelength related to how the wavelength is designed for use in recording or reproduction of each recording layer.

The drive device first reads information in this system area, and performs a servo draw-in operation, selection of a laser source equipped in an optical head, and the like based on the read data. Thus, since the operation of the drive can be readily set based on the information in the system area, the information has a high utility value.

In this connection, the system area may be provided on one or both of the surfaces on which the first recording layer is formed and the surface on which the second recording layer is formed. Also, when there are two or more recording layers, the system area may be provided on each layer, or may be provided on a plurality of surfaces of one or more layers that have been selected.

A description will be given of the recording on or reproduction from the optical disk according to the present invention. The recording on or reproduction from first recording layer 101 requires a first optical system which is equipped with laser light 21 at wavelength λ1 and objective lens 21 having numerical aperture NA1, while the recording on or reproduction from second recording layer 102 requires a second optical system which is equipped with laser light 22 at wavelength λ2 and objective lens 221 having numerical aperture NA2. Two recording or reproducing apparatuses comprising the first and second optical systems, respectively, may be used for recording or reproducing the respective layers. However, in one implementation where one recording or reproducing apparatus comprises the first and second optical systems, the one recording or reproducing apparatus can record or reproduce each layer. In this implementation, the recording or reproducing apparatus can readily perform operations such as a transfer of data recorded on the first recording layer (recorded data) to the second recording layer, and the like. In this way, the apparatus for recording or reproducing the optical disk according to the present invention may comprise two objective lenses independently of each other, or may employ a common lens which exhibits different focusing characteristics for two wavelengths.

For example, as illustrated in FIG. 6A, a useful recording or reproducing apparatus may be equipped with two optical heads disposed across a spindle motor for rotating the disk. Optical head 151 is equipped with an LD at wavelength λ1, for example, 405 nm and comprises an objective lens with NA=0.65. Optical head 152 is equipped with an LD at wavelength λ2, for example, 650 nm, and comprises an objective lens with NA=0.60. Each of optical heads 151, 152 has sufficient focusing performance for a disk having a substrate having a thickness of 0.6 mm. Optical head 151 and optical head 152 may be individually operated for performing recording or reproduction. Also, optical heads 151, 152 can be operated to simultaneously access one disk through optical heads 151, 152, as required.

In another configuration, an optical head which can be used may be equipped with two laser light sources in one housing. For example, as illustrated in FIG. 6B, two LD's 201, 202 which differ in wavelength from each other are equipped to define a light path for leading laser light from each LD 201, 202 to objective lens 231. Here, LD 201 emits laser light relevant to wavelength λ1, and an LD at a wavelength of 405 nm is used, by way of example. LD 202 emits laser light relevant to wavelength λ2, and an LD at a wavelength of 650 nm is used, by way of example. Phase compensation plate 232 which exhibits different phase characteristics depending on the wavelength is disposed immediately before objective lens 231, and thus functions to provide objective lens 231 with numerical aperture NA1 for λ1 and to provide objective lens 231 with numerical aperture NA2 for λ2. Also, by driving a lens actuator equipped with objective lens 231 in a focusing direction, laser light can be focused on each layer of the optical disk.

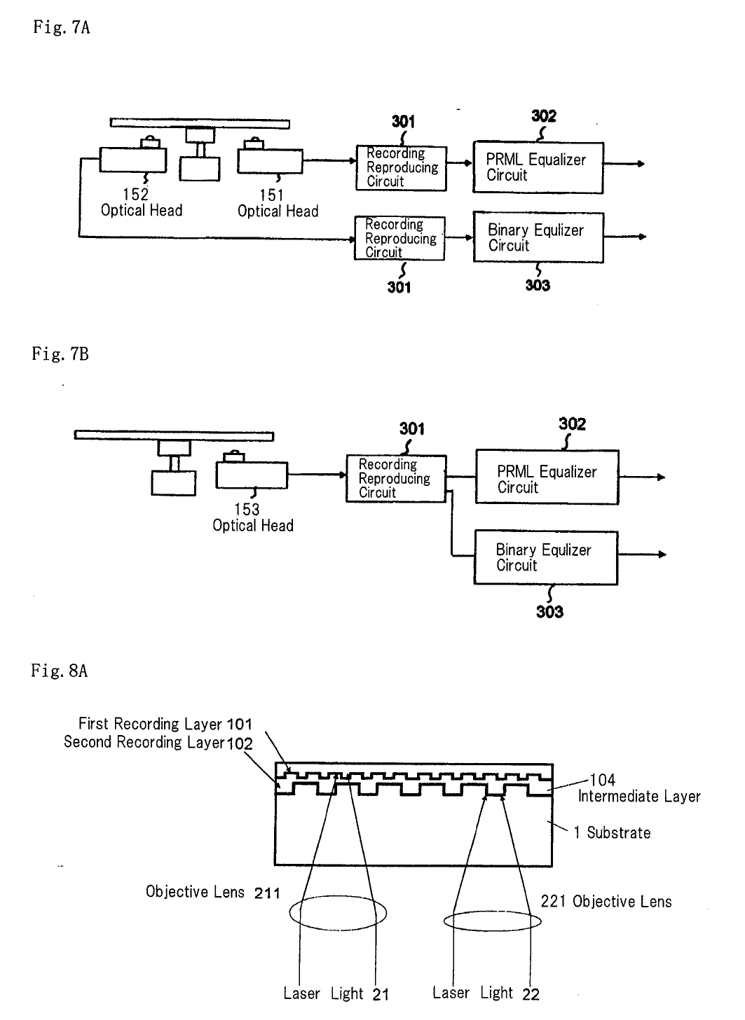

For ensuring sufficient recording or reproducing characteristics, PRML signal processing is employed for reproducing first recording layer 101 on which information is recorded at a higher density. Therefore, the recording/reproducing apparatus according to the present invention employs a configuration which comprises PRML equalizer circuit 302 subsequent to recording/reproducing circuit 301 for reproducing a signal on first recording layer 101, as illustrated in FIGS. 7A and 7B. On the other hand, the recording/reproducing apparatus employs a configuration which comprises binary equalizer circuit 303 subsequent to recording/reproducing circuit 301 for reproducing a signal on second recording layer 102. In the apparatus configured to comprise two optical heads 151, 152, as illustrated in FIG. 7A, PRML equalizer circuit 302 is disposed subsequent to recording/reproducing circuit 301 for recording/reproducing information through optical head 151, and binary equalizer circuit 303 is disposed subsequent to recording/reproducing circuit 301 for recording/reproducing information through optical head 152. On the other hand, in the apparatus configured to employ optical head 153 which comprises two LD's, as illustrated in FIG. 7B, the output of recording/reproducing circuit 301 is switched, in accordance with conditions for access to each layer to supply a signal to PRML equalizer circuit 302 and binary equalizer circuit 303.

Also, when the recording/reproducing apparatus is loaded with an optical disk and activated, the optical head first reproduces the disk identification flag recorded at a predetermined position of the disk at the time the apparatus is activated, and recognizes the disk type, functions of each layer, and corresponding laser wavelengths from the reproduced information. The reproduced signal at this time is sent to a control circuit. The control circuit selects an initial activation routine using the reproduced information.

Next, another embodiment of the present invention will be described in detail with reference to the drawings.

An optical disk, which is an optical information recording medium of the present invention, is of a type which is recorded or reproduced from one side through a substrate. The optical disk has two recording layers, where the first layer differs in recording density from the second layer.

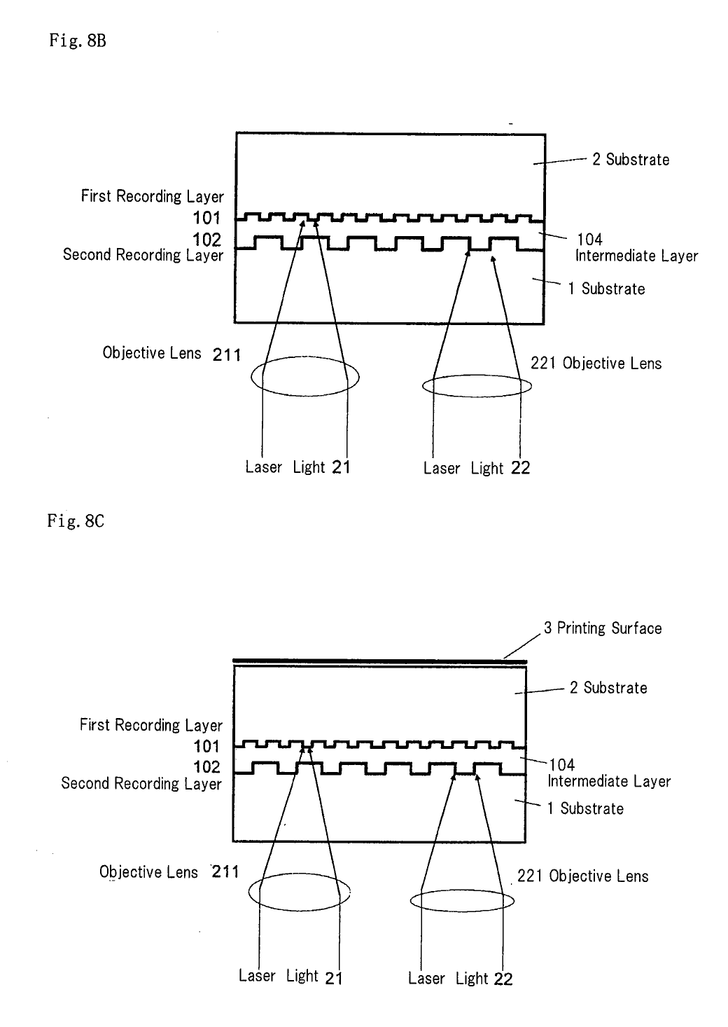

FIG. 8A is a cross-sectional view illustrating a representative structure of the optical disk according to another embodiment of the present invention. Second recording layer 102 and first recording layer 101 are laminated on disk substrate 1 in the order reverse to FIG. 1A. Laser light for recording or reproduction is incident through substrate 1. Structurally, the disk has two recording layers laminated on the side opposite to the laser light incident side. Intermediate layer 104, which is transparent to a first laser light, is formed between the first and second layers.

As mentioned above, the present invention is characterized by recording or reproducing information on or from the first and second layers using laser light with different wavelengths. Specifically, information is recorded on or reproduced from the first layer using an optical system which has second laser light 22 at wavelength λ2 and objective lens 221 having aperture numeral NA2. information is recorded on or reproduced from the second layer using an optical system which has first laser light 21 at wavelength λ1 and objective lens 211 having numerical aperture NA1.

The first layer differs from the second layer in recording density because the objective lenses for use in recording or reproduction have different NA's, and different signal processing methods are employed in a reproduction system. The recording density of the second layer is designed to satisfy a relationship P1<0.35×λ1/NA1, where P1 represents the length of the shortest pit. The recording density of the first layer is designed to satisfy P2>0.35×λ2>NA2, where P2 represents the length of the shortest pit. The recorded shortest pit on the second layer is smaller than that on the first layer because they are based on the premise that PRML (Partial Response Maximum Likelyfood) signal processing is used for reproduction from the second layer, as described above. In this way, even information recorded at a high density can be satisfactorily reproduced. In addition, the track pitch on the first layer is wider than that on the second layer because the different wavelengths result in different focused spot sizes.

The other embodiment of the present invention shown herein employs a disk substrate having a thickness of approximately 0.6 mm. Laser light for recording or reproduction is incident through the substrate. While the substrate itself may be transparent to the wavelength of the laser light that is used, the substrate is generally made of a resin represented by polycarbonate. When the substrate itself is required to be rigid, a glass substrate can be used as well.

In one implementation of the disk, two recording layers 102, 101 are laminated on the side opposite to the laser light incident side, as illustrated in FIG. 8A. Intermediate layer 104 is formed between the first and second layers. Intermediate layer 104 is sufficiently transparent to at least laser light for accessing the second recording layer. Intermediate layer 104 may be formed by spreading a transparent resin, or by uniformly adhering a film-like transparent thin film sheet.

This intermediate layer 104 is needed in order to distinguish focused positions on at least the first and second recording layers, and its thickness is required to be larger than at least focus depth Δz which is determined by numerical aperture NA of an objective lens and by laser light wavelength λ. For example, from Equation (1), when λ=405 nm, and NA=0.65, Δz=0.31 μm, so that the intermediate layer needs a thickness of 0.5 μm or more even if it is thinly formed.

On the other hand, the maximum value permitted for the thickness of the intermediate layer is determined from the aforementioned Equations (2), (3), (4), (5). Assuming that an intermediate layer having refractive index n and thickness Δd is added to the thickness of a substrate so that the thickness of the substrate changes by Δd, when λ=650 nm, NA=0.60, and n=1.56, for example, Δd<26.6 μm. Accordingly, assuming that allowable spherical aberration W₄₀ is limited to ±λ/4, information can be recorded on or reproduced from both recording layers at this wavelength within the allowable aberration conditions range when two recording layers are disposed within ±26.6 μm. Also, when λ=405 nm, NA=0.66, and n=1.56, for example, Δd<12.0 μm.

When thickness of the first substrate is set to 0.574 mm and thickness of the intermediate layer is set to 38 μm, if the second recording layer for wavelength λ2 is formed on the first substrate, and if after the formation of the intermediate layer the first recording layer for wavelength λ1 is formed on the intermediate layer, a medium which satisfies desired aberration conditions can be obtained.

First recording layer 101 and second recording layer 102 may be of a ROM type which is formed with pre-pits, or of a Write-Once type or a rewritable type which has a recording film formed on a groove. The two layers may be of the same type, or may be of different types such as ROM and Write-Once types, ROM and rewritable types, or Write-Once and rewritable types.

In the other embodiment according to the present invention shown herein, the first layer is recorded or reproduced by an optical system which has laser light 22 at wavelength λ2 and objective lens 221 having NA2, while the second layer is recorded or reproduced by an optical system which has laser light 21 at wavelength λ1 and objective lens 211 having NA1, so that second recording layer 102 formed in the first layer must have a desired transmittance to laser light 21 at wavelength λ1.

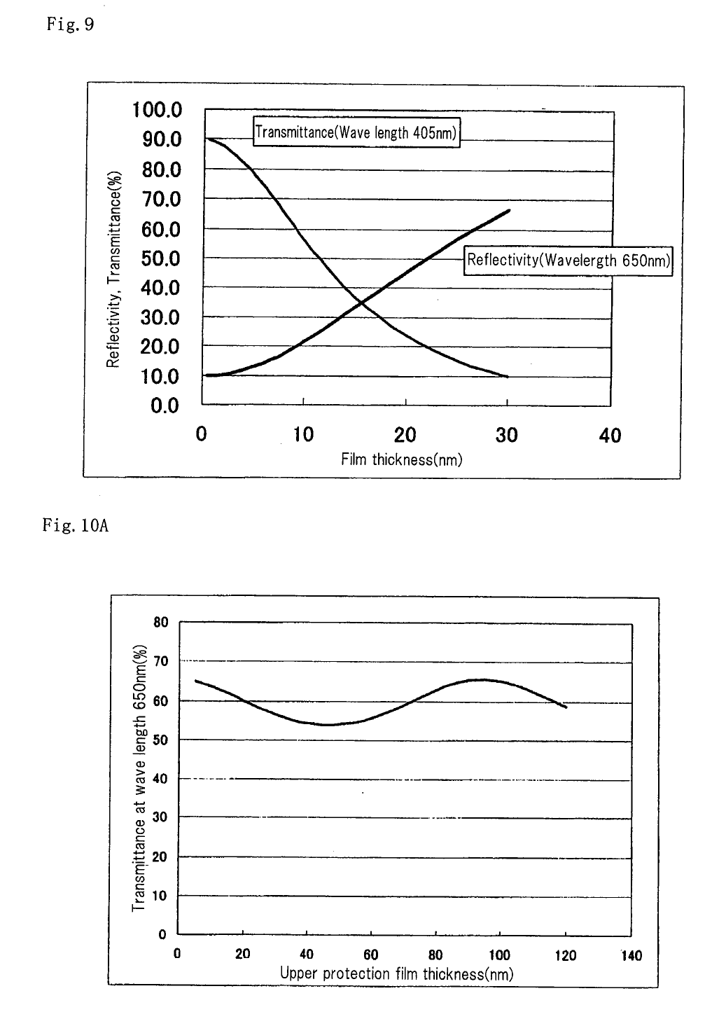

For example, when second recording layer 102 is Read-only ROM, a metal reflective film is formed on pre-pits area of the disk, whereas in the dual-layer structure in the other embodiment according to the present invention, a material must be selected for the metal reflective film such that the film exhibits a desired reflectivity to λ2 and simultaneously exhibits a fixed transmittance to λ1, and the film must also be adjusted in thickness. FIG. 9 is a characteristic diagram showing the dependence of the reflectivity to λ2 and the transmittance to λ1 on the film thickness when Ag is selected for the metal reflective film when wavelength λ1 of first laser light 21 is 405 nm and wavelength λ2 of second laser light 22 is 650 nm. The thickness reduced to less than 5 nm would result in the transmittance to λ1 equal to or higher than 85%, but the reflectivity to λ2 equal to or lower than 20%. If the thickness is set to 11 nm, the reflectivity of approximately 25% can be ensured to λ2. In this event, since the transmittance to λ1 is approximately 73%, data can be recorded on or reproduced from first recording layer 101 without a hitch.

For example, when second recording layer 102 is of the rewritable type, a phase change recording film is selected, the recording film itself is reduced in thickness, and the metal reflective film is also formed in a reduced thickness to improve the transmittance in order to additionally produce a heat radiation effect. In this way, first recording layer 101 can exhibit a desired reflectivity to λ2, and a fixed transmittance to λ1. FIGS. 10A and 10B show the transmittance to the wavelength of 405 nm and the reflectivity to the wavelength of 650 nm, when a lower protection film is 70 nm thick; when a GeSbTe phase change recording film is 5 nm thick; when an Ag reflective film is 10 nm thick, and when an interference film is 20 nm thick in a structure comprised of sequentially laminated substrate/ZnS—SiO₂ lower protection film/GeSbTe phase change recording film/ZnS—SiO₂ upper protection film/Ag reflective film/TiO₂ interference film. Though both change depending on the thickness of the upper protection film, when the thickness of the upper protection film is set to 40 nm, a crystal portion of the recording film exhibits a reflectivity of 6% to the wavelength of 650 nm, an amorphous portion of the recording film exhibits a reflectivity of 11% to the wavelength of 650 nm, and the average transmittance is 54% at a wavelength of 405 nm. In this way, when second recording layer 102 is chosen to be of the rewritable type, a transmittance of 50% or more can be achieved to the first recording layer 101, so that data can be recorded on or reproduced from first recording layer 101 without a hitch.

Likewise, when a Write-Once recording film made of an organic dye material, an inorganic metal material or the like is formed in second recording layer 102, a material which has a fixed transmittance to the first wavelength, though it absorbs the second wavelength, may be selected for second recording layer 102, or the recording layer may be reduced in thickness, whereby data can be recorded on or reproduced from first recording layer 101 without a hitch.

On the other hand, since first recording layer 101 is similar to the conventional substrate incident type single layer, smaller consideration may be given to the structure of the layer and materials used therefor. However, due to a lower transmittance to the recording layer as compared with the single-layer structure, a higher reflectivity is more preferably set for first recording layer 101.

The disk may have the two recording layers formed on a single plate having a thickness of 0.6 mm, but as illustrated in FIG. 8B, after first recording layer 101 has been previously formed on second substrate 2, first substrate 1 and second substrate 2 may be bonded to each other through intermediate layer 104 which is an adhesive layer, such that their recording layers oppose each other to strike a balance therebetween. In this case, as shown in FIG. 8C, the surface opposite to the laser light incident surface may be used as print surface 3 for visually displaying a title or the like of information recorded on the disk to facilitate the confirmation of contents. For example, a label, a title, an index indicative of contents, for example, can be printed on print surface 3. Also, like the aforementioned embodiment, a label, a title, an index indicative of contents, and the like printed in a film form may also be adhered on the substrate in this embodiment. In one implementation, the substrate surface may be printed or coated with a film such that the user himself can write information such as the label, title or the like. These can provide a disk having a user-friendly form.

Information is recorded on or reproduced from the disk using a drive device, but for identifying the type of the disk in the drive device, it is useful to form the disk itself with flag information for identifying the disk. In the other embodiment according to the present invention shown herein, a system control information area is also provided on part of the disk for recording a disk identification flag therein.

For recording or reproducing the optical disk, a useful recording or reproducing apparatus is configured to comprise two optical heads, for example, as illustrated in FIG. 6A, as is the case with the aforementioned embodiment.

In another configuration, it is possible to use an optical head which is equipped with two laser light sources in a single housing, as illustrated in FIG. 6B.

For ensuring sufficient recording or reproducing characteristics, PRML signal processing is employed to reproduce first recording layer 101 on which information is recorded at a higher density. Therefore, the recording/reproducing apparatus according to the other embodiment of the present invention employs a configuration which comprises PRML equalizer circuit 302 subsequent to recording/reproducing circuit 301 to reproduce a signal on first recording layer 101, as illustrated in FIG. 7, in a manner similar to the aforementioned embodiment. On the other hand, the recording/reproducing apparatus employs a configuration which comprises binary equalizer circuit 303 subsequent to recording/reproducing circuit 301 to reproduce a signal on second recording layer 102. In the apparatus configured to comprise two optical heads 151, 152, as illustrated in FIG. 7A, respective equalizer circuits 302, 303 are disposed subsequent to respective recording/reproducing circuits 301. On the other hand, in the apparatus configured to employ optical head 153 which comprises two LD's, as illustrated in FIG. 7B, the output of recording/reproducing circuit 301 is switched, in accordance with conditions for access to each layer to supply a signal to PRML equalizer circuit 302 and binary equalizer circuit 303 in a manner similar to the aforementioned embodiment.

### Example 1

A dual-layer ROM disk was fabricated to have a structure equivalent to that illustrated in FIG. 1B with wavelength λ1 set to 405 nm; NA1 to 0.65; wavelength λ2 to 650 nm; and NA2 to 0.60. In this fabricating step, a first substrate was fabricated by injection molding using a polycarbonate substrate having an outer diameter of 120 mm and a thickness of 0.59 mm. The resulting disk was formed with pre-pits in a spiral form on the surface. The track pitch was set to 0.40 μm, and the shortest pit length to 0.20 μm. Next, an Ag film having a thickness of 12 nm, which would serve as a first recording layer, was deposited on the pre-pits by a sputtering method.

Next, a second substrate formed with pre-pits in a spiral form on the surface was fabricated by injection molding using a polycarbonate substrate having an outer diameter of 120 mm and a thickness of 0.59 mm. In the second substrate, the track pitch was set to 0.74 μm, the shortest pit length to 0.40 μm, and a spiral track was reverse to that of the first substrate. Next, an Al—Ti alloy thin film having a thickness of 100 nm, which would serve as a second recording layer, was deposited on the pre-pits by a sputtering method. Next, an ultraviolet curable resin was spread on the Ag thin film of the first substrate, as an intermediate layer, and a resin layer of 20 μm thick was formed by a spin coating method. Next, both substrates were bonded to each other in such a manner that the Al—Ti thin film side of the second substrate was laid on the first substrate formed with the resin layer. Subsequently, curing ultraviolet rays were irradiated from the first substrate side to cure the resin film which would serve as the intermediate layer.

Next, the optical disk fabricated in a manner described above was evaluated for reproduction performance using optical head A, the specifications of which included a laser wavelength of 405 nm, and an objective lens having NA set to 0.65, and optical head B, the specifications of which included a laser wavelength of 650 nm, and an objective lens having NA set to 0.60.

First, an attempt was made to reproduce the first recording layer using optical head A from the first substrate side of the fabricated optical disk. The reflectivity from the Ag reflective film formed on the first recording layer was 24% in a flat region without pre-pits, and focus error signals and tracking error signals were sufficiently reproduced so as to perform a servo operation with stability. Satisfactory signals were reproduced from pre-pits of the disk, and reproduction was confirmed with a sufficiently low error rate by applying the PRML signal processing to the reproduced signal.

Subsequently, an attempt was made to reproduce the second recording layer using optical head B from the first substrate side of the created optical disk. The reflectivity from the second recording layer was 19% in a flat region without pre-pits, and focus error signals and tracking error signals were sufficiently reproduced so as to perform a servo operation with stability. Satisfactory signals were reproduced from pre-pits of the disk, and reproduction was confirmed with a sufficiently low error rate by applying the signal binarization processing to the reproduced signals.

### Example 2

A dual-layer disk was fabricated to have a structure equivalent to that illustrated in FIG. 1B with wavelength λ1 set to 405 nm; NA1 to 0.65; wavelength λ2 to 650 nm; and NA2 to 0.60. In this fabricating step, a first substrate was fabricated by injection molding using a polycarbonate substrate having an outer diameter of 120 mm and a thickness of 0.59 mm. The resulting disk was formed with pre-pits in a spiral form on the surface. The track pitch was set to 0.40 μm, and the shortest pit length to 0.20 μm. Next, an Ag film having a thickness of 12 nm, which would serve as a first recording layer, was deposited on the pre-pits by a sputtering method.

Next, a second substrate formed with a groove in a spiral form on the surface was fabricated by injection molding using a polycarbonate substrate having an outer diameter of 120 mm and a thickness of 0.59 mm. In the second substrate, the track pitch was set to 0.74 μm, a spiral track was reverse to that of the first substrate. Next, a second recording layer was formed by sequentially laminating an Ag and Al—Ti laminate reflective film (100 nm thick), ZnS—SiO₂ protection film (25 nm thick), a GeSbTe phase change recording film (12 nm thick), and a ZnS—SiO₂ protection film (160 nm thick) on the groove by a sputtering method. Next, an ultraviolet curable resin was spread on the Ag thin film of the first substrate, as an intermediate layer, and a resin layer having a thickness of 20 μm was formed by a spin coating method. Next, both substrates were bonded to each other in such a manner that the protection film of the second substrate was laid on the first substrate. Subsequently, curing ultraviolet rays were irradiated from the first substrate side to cure the resin film which would serve as the intermediate layer.

Next, the optical disk fabricated in a manner described above was evaluated for reproduction performance using optical head A, the specifications of which included a laser wavelength of 405 nm, and an objective lens having NA set to 0.65, and optical head B, the specifications of which included a laser wavelength of 650 nm, and an objective lens having NA set to 0.60.

First, an attempt was made to reproduce the first recording layer using optical head A from the first substrate side of the fabricated optical disk. The reflectivity from the Ag reflective film formed on the first recording layer was 24% in a flat region without pre-pits, and focus error signals and tracking error signals were reproduced enough to perform a servo operation with stability. Satisfactory signals were reproduced from pre-pits of the disk, and reproduction was confirmed with a sufficiently low error rate by applying the PRML signal processing to the reproduced signals.

Subsequently, an attempt was made to reproduce the second recording layer using optical head B from the first substrate side of the created optical disk. The reflectivity from the second recording layer was 7% in a groove region, and focus error signals and tracking error signals were sufficiently reproduced so as to perform a servo operation with stability. Satisfactory signals were reproduced from tracks on which data had been recorded, and reproduction was confirmed with a sufficiently low error rate by applying the signal binarization processing to the reproduced signal.

### Example 3

A dual-layer disk was fabricated to have a structure equivalent to that illustrated in FIG. 1B with wavelength λ1 set to 405 nm; NA1 to 0.65; wavelength λ2 to 650 nm; and NA2 to 0.60. In this fabricating step, a first substrate was fabricated by injection molding using a polycarbonate substrate having an outer diameter of 120 mm and a thickness of 0.59 mm. The resulting disk was formed with pre-pits in a spiral form on the surface. The track pitch was set to 0.40 μm, and the shortest pit length to 0.20 μm. Next, an Ag film having a thickness of 12 nm, which would serve as a first recording layer, was deposited on the pre-pits by a sputtering method.

Next, a second substrate formed with a groove in a spiral form on the surface was fabricated by injection molding using a polycarbonate substrate having an outer diameter of 120 mm and a thickness of 0.59 mm. In the second substrate, the track pitch was set to 0.74 μm, a spiral track was reverse to that of the first substrate. Next, a second recording layer was formed, as a Write-Once recording layer, by sequentially laminating an Al—Ti reflective film, a ZnS—SiO₂ protection film, a GeTe recording film, and a ZnS—SiO₂ protection film on the groove by a sputtering method. Next, an ultraviolet curable resin was spread on the Ag thin film of the first substrate, as an intermediate layer, and a resin layer having a thickness of 20 μm was formed by a spin coating method. Next, both substrates were bonded to each other in such a manner that the side of the second substrate formed with the recording layer was laid on the first substrate formed with the resin layer. Subsequently, curing ultraviolet rays were irradiated from the first substrate side to cure the resin film which would serve as the intermediate layer.

Next, the optical disk fabricated in a manner described above was evaluated for reproduction performance using optical head A, the specifications of which included a laser wavelength of 405 nm, and an objective lens having NA set to 0.65, and optical head B, the specifications of which included a laser wavelength of 650 nm, and an objective lens having NA set to 0.60.

First, an attempt was made to reproduce the first recording layer using optical head A from the first substrate side of the fabricated optical disk. The reflectivity from the Ag reflective film formed on the first recording layer was 24% in a flat region without pre-pits, and focus error signals and tracking error signals were sufficiently reproduced so as to perform a servo operation with stability. Satisfactory signals were reproduced from pre-pits of the disk, and reproduction was confirmed with a sufficiently low error rate by applying the PRML signal processing to the reproduced signals.

Subsequently, an attempt was made to reproduce the second recording layer using optical head B from the first substrate side of the created optical disk. The reflectivity from the second recording layer was 10% in a groove region, and focus error signals and tracking error signals were sufficiently reproduced so as to perform a servo operation with stability. Satisfactory signals were reproduced from tracks on which information had been recorded, and reproduction was confirmed with a sufficiently low error rate by applying the signal binarization processing to the reproduced signal.

### Example 4

A dual-layer disk was fabricated to have a structure equivalent to that illustrated in FIG. 1B with wavelength λ1 set to 405 nm; NA1 to 0.65; wavelength λ2 to 650 nm; and NA2 to 0.60. In this fabricating step, a first substrate was fabricated by injection molding using a polycarbonate substrate having an outer diameter of 120 mm and a thickness of 0.59 mm. The resulting disk was formed with a groove in a spiral form on the surface. The track pitch was set to 0.40 μm. Next, a first recording layer was formed by sequentially laminating a ZnS—SiO₂ lower protection film (70 nm thick), a GeSbTe phase change recording film (5 nm thick), a ZnS—SiO₂ upper protection film (35 nm thick), an Ag reflective film (10 nm thick), and TiO₂ interference film (20 nm thick) on the groove by a sputtering method.

Next, a second substrate formed with pre-pits in a spiral form on the surface was fabricated by injection molding using a polycarbonate substrate having an outer diameter of 120 mm and a thickness of 0.59 mm. In the second substrate, the track pitch was set to 0.74 μm, and the shortest pit length to 0.40 μm, where a spiral track was reverse to that of the first substrate. Next, an Al—Ti alloy thin film having a thickness of 200 nm, which would serve as a second recording layer, was deposited on the pre-pits by a sputtering method. Next, an ultraviolet curable resin was spread on the TiO₂ interference film of the first substrate, as an intermediate layer, and a resin layer having a thickness of 20 μm was formed by a spin coating method. Next, both substrates were bonded to each other in such a manner that the Al—Ti thin film side of the second substrate was laid on the first substrate formed with the resin layer. Subsequently, curing ultraviolet rays were irradiated from the first substrate side to cure the resin film which would serve as the intermediate layer.

Next, the optical disk fabricated in a manner described above was evaluated for reproduction performance using optical head A, the specifications of which included a laser wavelength of 405 nm, and an objective lens having NA set to 0.65, and optical head B, the specifications of which included a laser wavelength of 650 nm, and an objective lens having NA set to 0.60.

First, an attempt was made to reproduce the first recording layer using optical head A from the first substrate side of the fabricated optical disk. The reflectivity from the first recording layer was 17% in a groove region, and focus error signals and tracking error signals were sufficiently reproduced so as to perform a servo operation with stability. Subsequently, information was recorded on the track. Signals reproduced from the track were satisfactory, and reproduction was confirmed with a sufficiently low error rate by applying the PRML signal processing to the reproduced signals.

Subsequently, an attempt was made to reproduce the second recording layer using optical head B from the first substrate side of the created optical disk. The reflectivity from the second recording layer was 19% in a flat region without pre-pits, and focus error signals and tracking error signals were sufficiently reproduced so as to perform a servo operation with stability. Satisfactory signals were reproduced from pre-pits of the disk, and reproduction was confirmed with a sufficiently low error rate by applying the signal binarization processing to the reproduced signal.

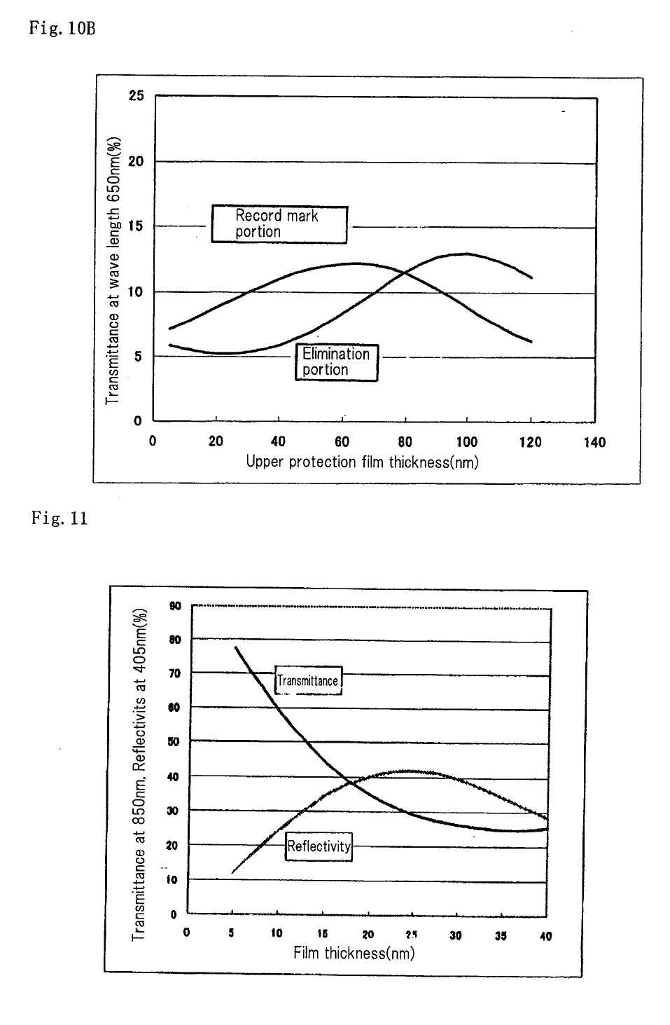

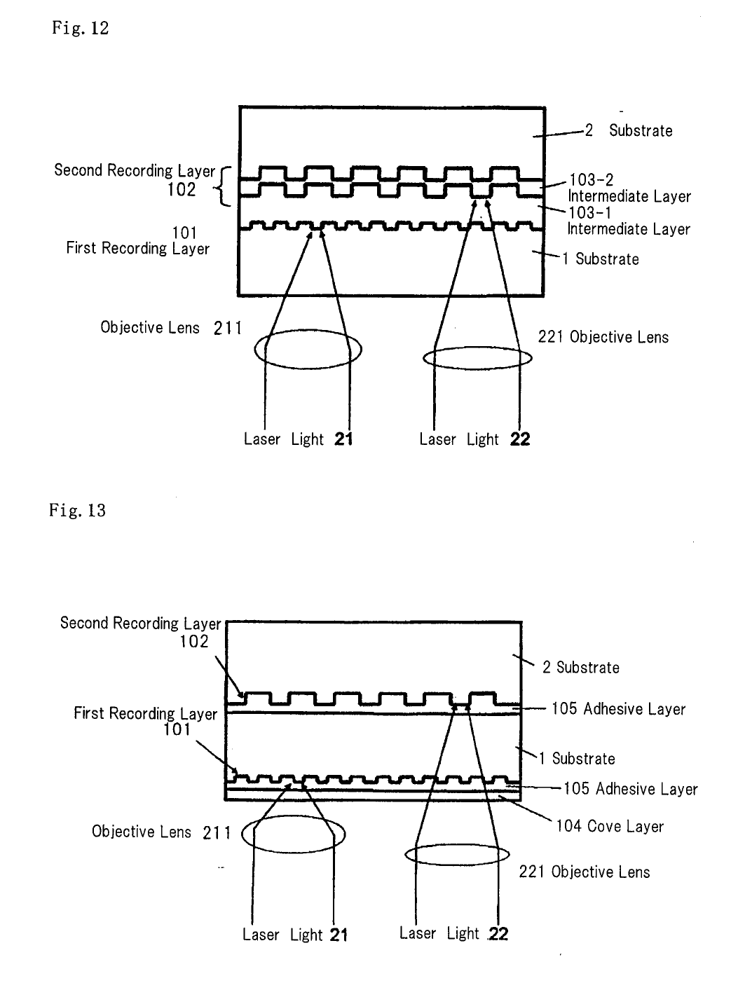

In another example where the first recording layer is, for example, a Read-only ROM, a thin film of a dielectric material can be formed on the pre-pits area of the disk. In the dual-layer structure of the present invention, the dielectric material is selected such that the film exhibits a desired reflectivity to λ1 and simultaneously exhibits a fixed transmittance to λ2, and the film must also be adjusted in thickness. FIG. 11 is a characteristic diagram showing the dependence of the reflectivity to λ1 and the transmittance to λ2 on the film thickness when an Si film formed by a sputtering method is selected for the dielectric material when wavelength λ1 of first laser light 21 is 405 nm and wavelength λ2 of second laser light 22 is 650 nm. The Si film that is formed exhibits optical constants (4.52, 0.15) at wavelength λ2 and barely absorbs wavelength λ2, so that the transmittance can be relatively increased. On the other hand, the Si film can ensure a fixed reflectivity because it exhibits optical constants (4.0, 1.5) at wavelength λ1. For example, when the thickness is chosen to be approximately 13 nm, the Si film exhibits a reflectivity of approximately 30% to wavelength λ1, and a transmittance of approximately 50% to wavelength λ2, so that data can be recorded on or reproduced from the second recording layer without a hitch. In the structure of this other example, for a film which substitutes for the Si film, a dielectric material can be used such as Ge, silicon nitride (SiNx), germanium nitride (GeNx), silicon hydrate (SiH), germanium hydrate (GeH), silicon oxynitride, germanium oxynitride, and the like, i.e., those which have a relatively large refractive index, and an absorption coefficient which differs at wavelengths λ1 and λ2.

In the foregoing examples, a single recording layer is formed for each wavelength, but in order to further increase the capacity at each wavelength, a recording layer formed for each wavelength can be comprised of a plurality of recording layers. For example, as illustrated in FIG. 12, first recording layer 101 for recording or reproducing information using laser light at wavelength λ1 can be comprised of a single layer, while second recording layer 102 for recording or reproducing information using laser light at wavelength λ2 can be comprised of two layers through intermediate layer 103-1 and additional intermediate layer 103-2.

While the foregoing examples of the present invention have shown a structure which has a first recording layer and a second recording layer laminated from the substrate side on which laser light is incident, the second recording layer and first recording layer may be sequentially laminated from the substrate side, as shown below. Also, it should be understood that the present invention can be applied as well when two or more layers are formed.

### Example 5

A dual-layer ROM disk was fabricated to have a structure equivalent to that illustrated in FIG. 8B with wavelength λ1 set to 405 nm; NA1 to 0.65; wavelength λ2 to 650 nm; and NA2 to 0.60. First, a first substrate, specifically, a substrate formed with pre-pits in a spiral form on the surface, was fabricated by injection molding using a polycarbonate substrate having an outer diameter of 120 mm and a thickness of 0.59 mm. The track pitch was set to 0.74 μm, and the shortest pit length to 0.40 μm. Next, an Ag film having a thickness of 11 nm was deposited on the pre-pits by a sputtering method to serve as a second recording layer. Next, a second substrate, specifically, a substrate formed with pre-pits in a spiral form on the surface, was fabricated by injection molding using a polycarbonate substrate having an outer diameter of 120 mm and a thickness of 0.59 mm. On this substrate, the track pitch was set to 0.40 μm, and the shortest pit length to 0.20 μm, where a spiral track was reverse to that of the first substrate. Next, an Al—Ti alloy thin film having a thickness of 100 nm was deposited on the pre-pits by a sputtering method to serve as a first recording layer. Subsequently, an ultraviolet curable resin was spread on the Ag thin film of the first substrate, as an intermediate layer, and formed to be 20 μm thick by a spin coating method. Both substrates were bonded to each other in such a manner that the Al—Ti thin film side of the second substrate was laid on the first substrate. Subsequently, curing ultraviolet rays were irradiated from the first substrate side to cure the resin film.

Next, the optical disk that was created was evaluated for reproduction performance using optical head A, the specifications of which included a laser wavelength of 405 nm, and an objective lens having NA set to 0.65, and optical head B, the specifications of which included a laser wavelength of 650 nm, and an objective lens having NA set to 0.60.

First, an attempt was made to reproduce the second recording layer using optical head B from the first substrate side of the created optical disk. The reflectivity from the Ag reflective film formed on the second recording layer was 42% in a flat region without pre-pits, and focus error signals and tracking error signals were sufficiently reproduced so as to perform a servo operation with stability. Satisfactory signals were reproduced from pre-pits of the disk, and reproduction was confirmed with a sufficiently low error rate by applying PRML signal processing to the reproduced signals.

Subsequently, an attempt was made to reproduce the first recording layer using optical head A from the first substrate side of the created optical disk. The reflectivity from the first recording layer was 39% in a flat region without pre-pits, and focus error signals and tracking error signals were sufficiently reproduced so as to perform a servo operation with stability. Satisfactory signals were reproduced from pre-pits of the disk, and reproduction was confirmed with a sufficiently low error rate by applying signal binarization processing to the reproduced signals.

### Example 6

A dual-layer disk was fabricated to have a structure equivalent to that illustrated in FIG. 8B with wavelength λ1 set to 405 nm; NA1 to 0.65; wavelength λ2 to 650 nm; and NA2 to 0.60. First, a first polycarbonate substrate having an outer diameter of 120 mm and a thickness of 0.59 mm, specifically, a substrate formed with pre-pits in a spiral form on the surface, was fabricated by injection molding. The track pitch was set to 0.74 μm, and the shortest pit length to 0.40 μm. Next, an Ag film having a thickness of 11 nm was deposited on the pre-pits by a sputtering method to serve as a second recording layer. Next, a second polycarbonate substrate having an outer diameter of 120 mm and a thickness of 0.59 mm, specifically, a substrate formed with a groove in a spiral form on the surface, was fabricated by injection molding. In this substrate, the track pitch was set to 0.40 μm, where a spiral track was reverse to that of the first substrate. Next, a first recording layer was formed by sequentially laminating an Al—Ti laminate reflective film (100 nm thick), a ZnS—SiO₂ protection film (20 nm thick), a GeSbTe phase change recording film (15 nm thick), and a ZnS—SiO₂ protection film (55 nm thick) on the groove by a sputtering method. Subsequently, an ultraviolet curable resin was spread on the Ag thin film of the first substrate, as an intermediate layer, and formed to be 20 μm thick by a spin coating method. Both substrates were bonded to each other in such a manner that the protection film side of the second substrate was laid on the first substrate. Subsequently, curing ultraviolet rays were irradiated from the first substrate side to cure the resin.

Next, the created optical disk was evaluated for reproduction performance using optical head A, the specifications of which included a laser wavelength of 405 nm, and an objective lens having NA set to 0.65, and optical head B, the specifications of which included a laser wavelength of 650 nm, and an objective lens having NA set to 0.60.

First, an attempt was made to reproduce the second recording layer using optical head B from the first substrate side of the created optical disk. The reflectivity from the Ag reflective film formed on the second recording layer was 42% in a flat region without pre-pits, and focus error signals and tracking error signals were sufficiently reproduced so as to perform a servo operation with stability. Satisfactory signals were reproduced from pre-pits of the disk, and reproduction was confirmed with a sufficiently low error rate by applying the PRML signal processing to the reproduced signals.

Subsequently, an attempt was made to reproduce the first recording layer using optical head A from the first substrate side of the created optical disk. The reflectivity from the first recording layer was 5% in a groove region, and focus error signals and tracking error signals were sufficiently reproduced so as to perform a servo operation with stability. Satisfactory signals were reproduced from tracks on which data had been recorded, and reproduction was confirmed with a sufficiently low error rate by applying signal binarization processing to the reproduced signals.

### Example 7

A dual-layer disk was fabricated to have a structure equivalent to that illustrated in FIG. 8B with wavelength λ1 set to 405 nm; NA1 to 0.65; wavelength λ2 to 650 nm; and NA2 to 0.60. First, a first polycarbonate substrate having an outer diameter of 120 mm and a thickness of 0.59 mm, specifically, a substrate formed with pre-pits in a spiral form on the surface, was fabricated by injection molding. The track pitch was set to 0.74 μm, and the shortest pit length to 0.40 μm. Next, an Ag film having a thickness of 11 nm was deposited on the pre-pits by a sputtering method to serve as a second recording layer. Next, a second polycarbonate substrate having an outer diameter of 120 mm and a thickness of 0.59 mm, specifically, a substrate formed with a groove in a spiral form on the surface, was fabricated by injection molding. In this substrate, the track pitch was set to 0.40 μm, where a spiral track was reverse to that of the first substrate. Next, a first recording layer was formed, as a Write-Once recording layer, by sequentially laminating an Al—Ti laminate reflective film, a ZnS—SiO₂ protection film, a GeTe recording film, and a ZnS—SiO₂ protection film on the groove by a sputtering method. Subsequently, an ultraviolet curable resin was spread on the Ag thin film of the first substrate, as an intermediate layer, and formed to be 20 μm thick by a spin coating method. Both substrates were bonded to each other in such a manner that the side of the second substrate on which the recording layer was formed was laid on the first substrate. Subsequently, curing ultraviolet rays were irradiated from the first substrate side to cure the resin film.

Next, the created optical disk was evaluated for reproduction performance using optical head A, the specifications of which included a laser wavelength of 405 nm, and an objective lens having NA set to 0.65, and optical head B, the specifications of which included a laser wavelength of 650 nm, and an objective lens having NA set to 0.60.

First, an attempt was made to reproduce the second recording layer using optical head B from the first substrate side of the created optical disk. The reflectivity from the Ag reflective film formed on the second recording layer was 42% in a flat region without pre-pits, and focus error signals and tracking error signals were sufficiently reproduced so as to perform a servo operation with stability. Satisfactory signals were reproduced from pre-pits of the disk, and reproduction was confirmed with a sufficiently low error rate by applying the PRML signal processing to the reproduced signals.

Subsequently, an attempt was made to reproduce the first recording layer using optical head A from the first substrate side of the created optical disk. The reflectivity from the first recording layer was 8% in a groove region, and focus error signals and tracking error signals were sufficiently reproduced so as to perform a servo operation with stability. Signals reproduced from a track on which information had been recorded were satisfactory, and reproduction was confirmed with a sufficiently low error rate by applying signal binarization processing to the reproduced signals.

### Example 8

A dual-layer disk was fabricated to have a structure equivalent to that illustrated in FIG. 8B with wavelength λ1 set to 405 nm; NA1 to 0.65; wavelength λ2 to 650 nm; and NA2 to 0.60. First, a first polycarbonate substrate having an outer diameter of 120 mm and a thickness of 0.59 mm, specifically, a substrate formed with a groove in a spiral form on the surface, was fabricated by injection molding. The track pitch was set to 0.74 μm. Next, a ZnS—SiO₂ lower protection film (70 nm thick), a GeSbTe phase change recording film (5 nm thick), a ZnS—SiO₂ upper protection film (40 nm thick), an Ag reflective film (10 nm thick), and TiO₂ interference film (20 nm thick) were sequentially laminated on the groove by a sputtering method as a second recording layer.

Next, a second polycarbonate substrate having an outer diameter of 120 mm and a thickness of 0.59 mm, specifically, a substrate formed with pre-pits in a spiral form on the surface, was fabricated by injection molding. In this substrate, the track pitch was set to 0.40 μm, and the shortest pit length to 0.20 μm, where a spiral track was reverse to that of the first substrate. Next, an Al—Ti alloy thin film having a thickness of 200 nm was deposited on the pre-pits by a sputtering method to serve as a first recording layer. Subsequently, an ultraviolet curable resin was spread on the TiO₂ interference film of the first substrate, as an intermediate layer, and formed to be 20 μm thick by a spin coating method. Both substrates were bonded to each other in such a manner that the Al—Ti thin film side of the second substrate was laid on the first substrate. Subsequently, curing ultraviolet rays were irradiated from the first substrate side to cure the resin.

Next, the created optical disk was evaluated for reproduction performance using optical head A, the specifications of which included a laser wavelength of 405 nm, and an objective lens having NA set to 0.65, and optical head B, the specifications of which included a laser wavelength of 650 nm, and an objective lens having NA set to 0.60.

First, an attempt was made to reproduce the second recording layer using optical head B from the first substrate side of the created optical disk. The reflectivity from the first recording layer was 8% in a groove region, and focus error signals and tracking error signals were sufficiently reproduced so as to perform a servo operation with stability. Subsequently, information was recorded on the track, and signals reproduced from the track were satisfactory, and reproduction was confirmed with a sufficiently low error rate by applying PRML signal processing to the reproduced signals.

Subsequently, an attempt was made to reproduce the first recording layer using optical head A from the first substrate side of the created optical disk. The reflectivity from the first recording layer was 21% in a flat region without pre-pits, and focus error signals and tracking error signals were sufficiently reproduced so as to perform a servo operation with stability. Signals reproduced from the pre-pits of the disk were satisfactory, and reproduction was confirmed with a sufficiently low error rate by applying the signal binarization processing to the reproduced signals.

In another example, where the second recording layer is, for example, a Read-only ROM, a thin film of a dielectric material can be formed on the pre-pits area of the disk. A dielectric material can be used such as Si, Ge, silicon nitride (SiNx), germanium nitride (GeNx), silicon hydrate (SiH), germanium hydrate, silicon oxynitride, germanium oxynitride, and the like, i.e., those which have a relatively large refractive index, and an absorption coefficient which differs at wavelengths λ1 and λ2.

### Example 9

In the structure of FIG. 8B relevant to Example 5, an allowance for the thickness of intermediate layer 103 was evaluated as part of investigations on the ease of manufacturing.

As described above, a maximum value permitted for the thickness of the intermediate layer is determined from aberration conditions of the objective lens. Assume that spherical aberration W₄₀ allowable to the objective lens is λ/4,

W₄₀={(n²−1)(NA)⁴/8n³}×Δd (2)

so that:

Δd<λ×2n3/{(n²−1)×NA⁴} (3)

For example, when λ=650 nm, NA=0.60, and n=1.56, Δd<26.6 μm.

However, in the recording on and reproduction from the second recording layer which has a lower recording density, favorable recording/reproduction can be accomplished even if the aberration condition is slightly alleviated, in which case the upper limit of thickness of the intermediate layer can be increased, resulting in a wider margin in the manufacturing of the disk.

For example, assume that spherical aberration W₄₀ allowable to the objective lens is λ/3,

Δd<λ×(8/3)×n³/{(n²−1)×NA⁴} (6)

so that when λ=650 nm, NA=0.60, and n=1.56, Δd<35.5 μm.

Thus, a plurality of dual-layer ROM disks were created for evaluation with wavelength λ1 set to 405 nm; NA1 to 0.65; wavelength λ2 to 650 nm; and NA2 to 0.60. They are comparable to the structure illustrated in FIG. 8B with a change in the thickness of the intermediate layer.

First, first polycarbonate substrates having an outer diameter of 120 mm and four different thicknesses, 0.55 mm, 0.56 mm, 0.57 mm, 0.58 mm, i.e., substrates formed with pre-pits in a spiral form on the surface, were created by injection molding. The track pitch was set to 0.74 μm, and the shortest pit length to 0.40 μm.

Next, an Ag film having a thickness of 11 nm was deposited on the pre-pits by a sputtering method to serve as a second recording layer. Next, a second polycarbonate substrate having an outer diameter of 120 mm and a thickness of 0.59 mm, specifically, a substrate formed with pre-pits in a spiral form on the surface, was fabricated by injection molding. In this substrate, the track pitch was set to 0.40 μm, and the shortest pit length to 0.20 μm, where a spiral track was reverse to that of the first substrate. Next, an Al—Ti alloy thin film having a thickness of 100 nm was deposited on the pre-pits by a sputtering method to serve as a first recording layer.

Subsequently, an ultraviolet curable resin was spread on the Ag thin film of the first substrate, as an intermediate layer, and formed to have a thickness shown in Table 1 by a spin coating method on each first polycarbonate substrate. Both substrates were bonded to each other in such a manner that the Al—Ti thin film side of the second substrate was laid on the first substrate. Subsequently, curing ultraviolet rays were irradiated from the first substrate side to cure the resin film. In these disks, the total thickness to the first recording layer (the total thickness of the substrate and intermediate layer) were set to 0.61 mm, so that the influence of aberration exerted on recording/reproduction of the first recording layer can be regarded as substantially constant.

TABLE 1
The Set Thickness Value of Intermediate Layer and Reproduction
Characteristic When First Substrate Was Varied in Thickness

| | | | | | | | | |
|---|---|---|---|---|---|---|---|---|
| Thickness of First | 0.55 | mm | 0.56 | mm | 0.57 | mm | 0.58 | mm |
| Substrate | | | | | | | | |
| Thickness of Intermediate | 60 | μm | 50 | μm | 40 | μm | 30 | μm |
| Laye | | | | | | | | |
| Reproduction | 12 | | 7 | | 7 | | 8 | |
| Characteristic (Jitter %) | | | | | | | | |

Next, the second recording layers formed on the first substrates of the created optical disks were evaluated for reproduction performance using optical head B, the specifications of which included a laser wavelength of 650 nm, and an objective lens having NA set to 0.60.

In the disks, focus error signals and tracking error signals were sufficiently reproduced so as to perform a servo operation with stability. Signal jitter reproduced from pre-pits of the disks was equal to or less than 8% which is an allowable value, except for the disk which had the intermediate layer having a thickness of 60 μm, and reproduction was confirmed with a sufficiently low error rate. However, the disk having the intermediate layer having a thickness of 60 μm presented high jitter and did not achieve satisfactory reproduction.

It can be confirmed from the foregoing measurements and evaluations that satisfactory recording/reproduction can be accomplished in regard to the recording/reproduction of a recording layer which has a low recording density, even if the aberration condition is slightly alleviated and the intermediate layer is set to a larger thickness.

1. An optical information recording medium which comprises at least two recording layers in which recorded data is formed on a substrate along a spiral or a concentric recording track, wherein in said optical information recording medium data is recorded or reproduced through the substrate, characterized in that:
a first recording layer is recorded or reproduced using first laser light at wavelength λ1, focused by an objective lens having a numerical aperture NA1, wherein the shortest pit length P1 of recorded or reproduced data has a value within a predetermined range determined by λ1 and NA1,
a second recording layer is recorded or reproduced using second laser light at wavelength λ2 that is longer than the wavelength λ1 of the first layer light, said second laser light being focused by an objective lens having a numerical aperture NA2 equal to or smaller than NA1, wherein the shortest pit length P2 of recorded or reproduced data has a value larger than a value determined by λ2 and NA2, and
a track pitch of the first recording layer is narrower than a track pitch of the second recording layer.

2. An optical information recording medium which comprises two recording layers in which recorded data is formed on a substrate along a spiral or a concentric recording track, wherein in said optical information recording medium data is recorded or reproduced through the substrate, characterized in that:
a first recording layer is recorded thereon or reproduced using first laser light at wavelength λ1, focused by an objective lens having a numerical aperture NA1, wherein the shortest pit length P1 of recorded or reproduced data satisfies a relationship represented by 0.167×λ1/NA1<P1<0.35×λ1/NA1,
a second recording layer is recorded or reproduced using second laser light at wavelength λ2 longer than the wavelength λ1 of the first layer light, said second laser light being focused by an objective lens having a numerical aperture NA2 equal to or smaller than NA1, wherein the shortest pit length P2 of recorded or reproduced data satisfies a relationship represented by P2>0.35×λ2/NA2, and
a track pitch of the first recording layer is narrower than a track pitch of the second recording layer.

3. The optical information recording medium according to claim 1, characterized by an intermediate layer formed between said first recording layer and said second recording layer, said intermediate layer being transparent to at least the first laser light or the second laser light or both the first laser light and the second laser light.

4. The optical information recording medium according to claim 1, characterized by having at least a second substrate on said two recording layers, and providing a print surface on said second substrate.

5. The optical information recording medium according to claim 3, characterized in that a thickness d of said intermediate layer which has a refractive index n and which is formed between said first recording layer and said second recording layer and is set to a value between a first value determined by λ1 and NA1 and a second value determined by λ1, n, NA1, λ2, and NA2.

6. The optical information recording medium according to claim 3, characterized in that a thickness d of said intermediate layer which has a refractive index n and which is formed between said first recording layer and said second recording layer satisfies a relationship represented by:
λ1/{π×(NA1)²}≦d<λ1×2n³/{(n²−1)×(NA1)⁴}+λ2×2n³/{(n²−1)×(NA2)⁴}

7. The optical information recording medium according to claim 1 for recording or reproducing data on or from a corresponding recording layer from among at least two recording layers formed on a substrate, characterized in that unique information that is related to operations of a drive device for driving said optical information recording medium is recorded in a system information recording area formed in a predetermined zone.

8. The optical information recording medium according to claim 7, characterized in that information related to the number of recording layers, and information related to a wavelength for use in recording or reproduction of each recording layer are recorded in said system information recording area.

9. The optical information recording medium according to claim 7, characterized in that information related to the number of recording layers, and information related to which Read-only type, Write-Once type, and rewritable type each recording layer belongs to, are recorded in said system information recording area.

10. The optical information recording medium according to claim 7, characterized in that said system information recording area is formed in a particular radial region.

11. The optical information recording medium according to claim 1, characterized in that a thin film of a dielectric material is formed on said first recording layer.

12. The optical information recording medium according to claim 11, characterized in that said dielectric material is Si, Ge, silicon nitride (SiNx), germanium nitride (GeNx), silicon hydrate (SiH), germanium hydrate, silicon oxynitride, or germanium oxynitride.

13. An optical information recording/reproducing apparatus for recording or reproducing an optical information recording medium which comprises at least two recording layers in which recorded data is formed on a substrate along a spiral or a concentric recording track, wherein in said optical information recording medium data is recorded or reproduced through the substrate, and wherein said optical information recording medium comprising:
a first recording layer for recording or reproducing data thereon or therefrom using a first laser light at wavelength λ1, focused by an objective lens having a numerical aperture NA1, wherein the shortest pit length P1 of recorded or reproduced data has a value within a predetermined range determined by λ1 and NA1; and
a second recording layer for recording or reproducing data thereon or therefrom using a second laser light at wavelength λ2 that is longer than the wavelength λ1 of the first layer light, said second laser light being focused by an objective lens having a numerical aperture NA2 equal to or smaller than NA1, wherein the shortest pit length P2 of recorded or reproduced data has a value larger than a value determined by λ2 and NA2, said apparatus characterized in that:
data is recorded or reproduced through the substrate, and
data on the first recording layer read by the first laser light is reproduced through partial response equalization, and data on the second recording layer read by the second laser light is reproduced through binary equalization.

14. An optical information recording/reproducing apparatus for recording or reproducing data on or from an optical information recording medium which comprises two recording layers in which recorded data is formed on a substrate along a spiral or a concentric recording track, wherein in said optical information recording medium data is recorded or reproduced through the substrate, and wherein said optical information recording medium comprising:
a first recording layer for recording or reproducing data thereon or therefrom using a first laser light at wavelength λ1, focused by an objective lens having a numerical aperture NA1, wherein the shortest pit length P1 of recorded or reproduced data satisfies a relationship represented by 0.167×λ1/NA1<P1<0.35×λ1/NA1; and
a second recording layer for recording or reproducing data thereon or therefrom using a second laser light at wavelength λ2 that is longer than the wavelength λ1 of the first layer light, said second laser light being focused by an objective lens having a numerical aperture NA2 equal to or smaller than NA1, wherein the shortest pit length P2 of recorded or reproduced data satisfies a relationship represented by P2>0.35×λ2/NA2, said apparatus characterized in that:
data is recorded or reproduced through the substrate,
the wavelength λ1 of the first laser light is in a range of 390 nm to 430 nm, and the wavelength λ2 of the second laser light is in a range of 630 nm to 690 nm, and
data on the first recording layer is reproduced through partial response equalization, and recorded data on the second recording layer is reproduced through binary equalization.

15. An optical recording/reproducing apparatus characterized by comprising:
two laser diodes for emitting laser light at different wavelengths;
a light path for leading the laser light from said two laser diodes to objective lenses;
a phase compensation plate disposed immediately before each said objective lens, and exhibiting different phase characteristics depending on the wavelength; and
driving means for driving a lens actuator equipped with said objective lenses in a focusing direction.

16. A method of manufacturing an optical information recording medium characterized by the steps of:
forming a first substrate having pre-pits formed in a spiral form on a surface through injection molding;
forming an Ag film on the pre-pits by a sputtering method to form a first recording layer;
forming a second substrate having pre-pits formed in a spiral form reverse to those on said first substrate on a surface by injection molding;
forming an Al—Ti alloy thin film on the pre-pits of said second substrate by a sputtering method to form a second recording layer;
coating an ultraviolet curable resin on the Ag film on said first substrate by a spin coating method to form an intermediate layer; and
bonding both said substrates such that the Al—Ti thin film side of said second substrate is laid on said first substrate, followed by irradiation by the curing ultraviolet rays from the first substrate side to cure the resin.

17. A method of manufacturing an optical information recording medium characterized by the steps of:
forming a first substrate having pre-pits formed in a spiral form on a surface through injection molding;
forming an Ag film on the pre-pits by a sputtering method to form a first recording layer;
forming a second substrate having a groove formed in a spiral form reverse to those on said first substrate on a surface by injection molding;
sequentially laminating a laminate reflective film of Ag and Al—Ti, a ZnS—SiO₂ protection film, a GeSbTe phase change recording film, and a ZnS—SiO₂ protection film on the groove of said second substrate by a sputtering method to form a second recording layer;
coating an ultraviolet curable resin on the Ag film of said first substrate by a spin coating method to form an intermediate layer; and
bonding both said substrates such that the protection film side of said second substrate is laid on said first substrate, followed by irradiation by the curing ultraviolet rays from the first substrate side to cure the resin.

18. A method of manufacturing an optical information recording medium characterized by comprising the steps of:
forming a first substrate having pre-pits formed in a spiral form on a surface through injection molding;
forming an Ag film on the pre-pits by a sputtering method to form a first recording layer;
forming a second substrate having a groove formed in a spiral form reverse to those on said first substrate on a surface by injection molding;
sequentially laminating an Al—Ti reflective film, a ZnS—SiO₂ protection film, a GeTe recording film, and a ZnS—SiO₂ protection film on the groove of said second substrate by a sputtering method to form a second recording layer as a Write-Once recording layer;
coating an ultraviolet curable resin on the Ag film of said first substrate by a spin coating method to form an intermediate layer; and
bonding both said substrates such that the formed recording layer side of said second substrate is laid on said first substrate, followed by irradiation by the curing ultraviolet rays from the first substrate side to cure the ultraviolet curable resin.

19. A method of manufacturing an optical information recording medium characterized by comprising the steps of:
forming a first substrate having a groove formed in a spiral form on a surface through injection molding;
sequentially laminating a ZnS—SiO₂ lower protection film, a GeSbTe phase change recording film, a ZnS—SiO₂ upper protection film, an Ag reflective film, and a TiO₂ interference film on the groove of said first substrate by a sputtering method as a first recording layer;
forming a second substrate having pre-pits formed in a spiral form reverse to those on said first substrate on a surface by injection molding;
forming an Al—Ti alloy thin film on the pre-pits by a sputtering method to form a second recording layer;
coating an ultraviolet curable resin on the TiO₂ interference film of said first substrate by a spin coating method to form an intermediate layer; and
bonding both said substrates such that the Al—Ti thin film side of said second substrate is laid on said first substrate, followed by irradiation by the curing ultraviolet rays from the first substrate side to cure the ultraviolet curable resin.

20. The optical information recording medium according to claim 2, characterized by having at least a second substrate on said two recording layers, and providing a print surface on said second substrate.

21. The optical information recording medium according to claim 2, characterized by having at least a second substrate on said two recording layers, and providing a print surface on said second substrate.

22. The optical information recording medium according to claim 3, characterized by having at least a second substrate on said two recording layers, and providing a print surface on said second substrate.

23. The optical information recording medium according to claim 4, characterized in that a thickness d of said intermediate layer which has a refractive index n and which is formed between said first recording layer and said second recording layer and is set to a value between a first value determined by λ1 and NA1 and a second value determined by λ1, n, NA1, λ2, and NA2.

24. The optical information recording medium according to claim 4, characterized in that a thickness d of said intermediate layer which has a refractive index n and which is formed between said first recording layer and said second recording layer satisfies a relationship represented by:
λ1/{π×(NA1)²}<d<λ1×2n³/{(n²−1)×(NA1)⁴}+λ2×2n³/{(n²−1)×(NA2)⁴}

25. The optical information recording medium according to claim 2 for recording or reproducing data on or from a corresponding recording layer from among at least two recording layers formed on a substrate, characterized in that unique information that is related to operations of a drive device for driving said optical information recording medium is recorded in a system information recording area formed in a predetermined zone.

26. The optical information recording medium according to claim 3 for recording or reproducing data on or from a corresponding recording layer from among at least two recording layers formed on a substrate, characterized in that unique information that is related to operations of a drive device for driving said optical information recording medium is recorded in a system information recording area formed in a predetermined zone.

27. The optical information recording medium according to claim 4 for recording or reproducing data on or from a corresponding recording layer from among at least two recording layers formed on a substrate, characterized in that unique information that is related to operations of a drive device for driving said optical information recording medium is recorded in a system information recording area formed in a predetermined zone.

28. The optical information recording medium according to claim 5 for recording or reproducing data on or from a corresponding recording layer from among at least two recording layers formed on a substrate, characterized in that unique information that is related to operations of a drive device for driving said optical information recording medium is recorded in a system information recording area formed in a predetermined zone.

29. The optical information recording medium according to claim 6 for recording or reproducing data on or from a corresponding recording layer from among at least two recording layers formed on a substrate, characterized in that unique information that is related to operations of a drive device for driving said optical information recording medium is recorded in a system information recording area formed in a predetermined zone.

30. The optical information recording medium according to claim 8, characterized in that said system information recording area is formed in a particular radial region.

31. The optical information recording medium according to claim 9, characterized in that said system information recording area is formed in a particular radial region.

32. The optical information recording medium according to claim 2, characterized in that a thin film of a dielectric material is formed on said first recording layer.

33. The optical information recording medium according to claim 3, characterized in that a thin film of a dielectric material is formed on said first recording layer.

34. The optical information recording medium according to claim 4, characterized in that a thin film of a dielectric material is formed on said first recording layer.

35. The optical information recording medium according to claim 5, characterized in that a thin film of a dielectric material is formed on said first recording layer.

36. The optical information recording medium according to claim 6, characterized in that a thin film of a dielectric material is formed on said first recording layer.

37. The optical information recording medium according to claim 7, characterized in that a thin film of a dielectric material is formed on said first recording layer.

38. The optical information recording medium according to claim 8, characterized in that a thin film of a dielectric material is formed on said first recording layer.

39. The optical information recording medium according to claim 9, characterized in that a thin film of a dielectric material is formed on said first recording layer.

40. The optical information recording medium according to claim 10, characterized in that a thin film of a dielectric material is formed on said first recording layer.
